(19) United States
(12) Patent Application Publication
(10) Pub. No.: US 2018/0190258 A1
(43) Pub. Date: Jul. 5, 2018

(54) ADAPTATIONS FOR ACTIVE NOISE CANCELLATION INSIDE A VEHICLE

(71) Applicant: QUALCOMM Incorporated, San Diego, CA (US)

(72) Inventors: Asif Iqbal Mohammad, San Diego, CA (US); Rishabh Tyagi, Hyderabad (IN); Erik Visser, San Diego, CA (US); Rogerio Guedes Alves, Macomb Township, MI (US)

(21) Appl. No.: 15/639,892

(22) Filed: Jun. 30, 2017

Related U.S. Application Data
(60) Provisional application No. 62/440,945, filed on Dec. 30, 2016.

(51) Int. Cl. G10K 11/178; G10L 15/02; G10L 15/22

(52) U.S. Cl. CPC G10K 11/1786; G10K 11/1788; G10L 15/02; G10L 2015/223; G10K 2210/1282; G10K 2210/3046; G10K 2210/3028; G10L 15/22

(57) ABSTRACT

Adaptations for in-vehicle adaptive noise-canceling (ANC) technology are described. An example in-vehicle audio system includes ANC circuitry coupled to one or more error microphones. The ANC circuitry being configured to process audio data received from the one or more error microphones to determine a distinction between the engine-external noise and the engine noise. The ANC circuitry is further configured to alter, based on the distinction determined between the engine-external noise and the engine noise, a convergence between two or more ANC filters to form altered-convergence ANC filtering coefficients.

This application claims the benefit of U.S. Provisional Application No. 62/440,945, filed Dec. 30, 2016, the entire content of which is incorporated by reference herein.

### TECHNICAL FIELD

This disclosure generally relates to audio signal processing and, more specifically, applying active noise cancellation to audio signals.

### BACKGROUND

Vehicles are almost ubiquitously equipped with entertainment or infotainment systems, which output audio feeds via loudspeakers. However, vehicle occupants' enjoyment of the audio output is often diminished due to the interference of ambient sounds, such as engine noise and other noises originating from sources that are external to the vehicle. In some cases, the extraneous noises may make it difficult for vehicle occupants to understand or even hear reproductions of soundfields (e.g., speech, music, etc.) output from the vehicle's loudspeakers. To alleviate the diminishment of the user experience, many in-vehicle audio systems implement active noise cancellation (ANC) technology. ANC refers to a way by which the in-vehicle audio systems adjust audio signals to account for environmental, background or ambient noises.

### SUMMARY

In general, techniques are described for adjusting active noise cancellation (ANC) output in a manner that more effectively targets the ambient noise interference at a given time. For instance, the ANC techniques of this disclosure distinguish between engine noise, which tends to be prolonged, and engine-external noise, which tends to be relatively ephemeral. ANC systems of this disclosure, in turn, use the distinction between engine noise and engine-external noise to form a noise canceling audio signal that counteracts the engine noise while downplaying or potentially disregarding certain engine-external noises. By disregarding certain engine-external noises, ANC systems of this disclosure may generate noise canceling audio signals that do not include noise-canceling sounds addressing past engine-external noises that are no longer interfering with occupant-audible output of the infotainment audio. As one example, the ANC systems of this disclosure may drop noise-canceling audio data that the ANC system formed in response to detecting a “bump” or “thump” sound associated with the vehicle running over a reflective stud on a lane marker.

In one aspect, a method includes capturing, by one or more error microphones of an in-vehicle audio system, engine noise associated with a vehicle engine, and capturing, by the one or more error microphones of the in-vehicle audio system, engine-external noise associated with one or more sources different from the vehicle engine. The method further includes processing, by adaptive noise-canceling (ANC) circuitry of the in-vehicle audio system, audio data received from the one or more error microphones to determine a distinction between the engine-external noise and the engine noise, and altering, by the ANC circuitry of the in-vehicle audio system, a convergence between two or more ANC filters to form altered-convergence ANC filtering coefficients, based on the distinction determined between the engine-external noise and the engine noise. The method may further include applying, by one or more speakers of the in-vehicle audio system, the altered-convergence ANC filtering coefficients to the processed audio data to add a noise-canceling component to the processed audio data to form noise-canceled audio data.

In another aspect, an in-vehicle audio system includes one or more error microphones, and adaptive noise-canceling (ANC) circuitry coupled to the one or more error microphones. The one or more error microphones are configured to capture engine noise associated with a vehicle engine, and to capture engine-external noise associated with one or more sources different from the vehicle engine. The ANC circuitry is configured to process audio data received from the one or more error microphones to determine a distinction between the engine-external noise and the engine noise, and based on the distinction determined between the engine-external noise and the engine noise, alter a convergence between two or more ANC filters to form an altered-convergence ANC filtering coefficients. The in-vehicle audio system may also include one or more speakers coupled to the ANC circuitry. The one or more speakers may be configured to apply the altered-convergence ANC filtering coefficients to the processed audio data to add a noise-canceling component to the processed audio data to form noise-canceled audio data.

In another aspect, a method includes capturing, by one or more error microphones of an in-vehicle audio system, engine noise associated with a vehicle engine, and capturing, by the one or more error microphones of the in-vehicle audio system, engine-external noise associated with one or more sources different from the vehicle engine. The method further includes processing, by adaptive noise-canceling (ANC) circuitry of the in-vehicle audio system, audio data received from the one or more error microphones to determine a distinction between the engine-external noise and the engine noise, and altering, by the ANC circuitry of the in-vehicle audio system, a convergence between two or more ANC filters to form altered-convergence ANC filtering coefficients, based on the distinction determined between the engine-external noise and the engine noise.

In another aspect, an in-vehicle audio system includes one or more error microphones, and adaptive noise-canceling (ANC) circuitry coupled to the one or more error microphones. The one or more error microphones are configured to capture engine noise associated with a vehicle engine, and to capture engine-external noise associated with one or more sources different from the vehicle engine. The ANC circuitry is configured to process audio data received from the one or more error microphones to determine a distinction between the engine-external noise and the engine noise, and based on the distinction determined between the engine-external noise and the engine noise, alter a convergence between two or more ANC filters to form an altered-convergence ANC filtering coefficients.

In another aspect, a method includes receiving, by adaptive noise-canceling (ANC) circuitry of an in-vehicle audio system, one or more revolutions per minute (RPM) measurements associated with a vehicle engine from a powertrain control module (PCM) coupled to the vehicle engine, generating, by the ANC circuitry of the in-vehicle audio system, a phase-inverted version of projected engine noise data based on the received RPM measurements, and generating, by the ANC circuitry of the in-vehicle audio system, an antinoise signal based on the phase-inverted version of the projected engine noise and engine delay information. The method further includes calculating, by the ANC circuitry of the in-vehicle audio system, energy parameter data associated with an error signal received from one or more error microphones positioned in the vehicle, and calculating, by the ANC circuitry of the in-vehicle audio system, a similarity measure between the error signal and the projected engine noise. The method may include performing, by the ANC circuitry of the in-vehicle audio system, responsive to determining that the energy parameter data does not exceed the similarity measure, ANC using the generated antinoise signal. The method may include updating, by the ANC circuitry of the in-vehicle audio system, responsive to determining that the energy parameter data exceeds the similarity measure, an ANC filter convergence associated with the antinoise signal to form an updated antinoise signal, and performing ANC using the updated antinoise signal.

In another aspect, an in-vehicle audio system includes means for capturing engine noise associated with a vehicle engine engine-external noise associated with one or more sources different from the vehicle engine, means for processing audio data received from the one or more error microphones to determine a distinction between the engine-external noise and the engine noise, means for altering a convergence between two or more ANC filters to form altered-convergence ANC filtering coefficients, based on the distinction determined between the engine-external noise and the engine noise, and means for applying the altered-convergence ANC filtering coefficients to the processed audio data to add a noise-canceling component to the processed audio data to form noise-canceled audio data.

In another aspect, an in-vehicle audio system includes means for obtaining one or more revolutions per minute (RPM) measurements associated with a vehicle engine from a powertrain control module (PCM) coupled to the vehicle engine, means for generating, by the ANC circuitry of the in-vehicle audio system, a phase-inverted version of projected engine noise data based on the obtained RPM measurements, means for generating an antinoise signal based on the phase-inverted version of the projected engine noise and engine delay information, and means for calculating energy parameter data associated with an error signal received from one or more error microphones positioned in the vehicle. The in-vehicle audio system further includes means for calculating a similarity measure between the error signal and the projected engine noise, means for performing, responsive to determining that the energy parameter data does not exceed the similarity measure ANC using the generated antinoise signal, means for updating, responsive to determining that the energy parameter data exceeds the similarity measure, an ANC filter convergence associated with the antinoise signal to form an updated antinoise signal, and means for performing, responsive to determining that the energy parameter data exceeds the similarity measure, ANC using the updated antinoise signal.

In another aspect, a computer-readable storage medium is encoded with instructions. The instructions, when executed, cause processing circuitry of an in-vehicle audio system to capture, via one or more error microphones of the in-vehicle audio system, engine noise associated with a vehicle engine, to capture, using the one or more error microphones of the in-vehicle audio system, engine-external noise associated with one or more sources different from the vehicle engine, to process, using adaptive noise-canceling (ANC) circuitry of the in-vehicle audio system, audio data received from the one or more error microphones to determine a distinction between the engine-external noise and the engine noise, to alter, using the ANC circuitry of the in-vehicle audio system, a convergence between two or more ANC filters to form altered-convergence ANC filtering coefficients, based on the distinction determined between the engine-external noise and the engine noise, and to apply, using one or more speakers of the in-vehicle audio system, the altered-convergence ANC filtering coefficients to the processed audio data to add a noise-canceling component to the processed audio data to form noise-canceled audio data.

In another aspect, a computer-readable storage medium is encoded with instructions. The instructions, when executed, cause processing circuitry of an in-vehicle audio system to capture, via one or more error microphones of the in-vehicle audio system, engine noise associated with a vehicle engine, to capture, using the one or more error microphones of the in-vehicle audio system, engine-external noise associated with one or more sources different from the vehicle engine, to process, using adaptive noise-canceling (ANC) circuitry of the in-vehicle audio system, audio data received from the one or more error microphones to determine a distinction between the engine-external noise and the engine noise, and to alter, using the ANC circuitry of the in-vehicle audio system, a convergence between two or more ANC filters to form altered-convergence ANC filtering coefficients, based on the distinction determined between the engine-external noise and the engine noise.

The details of one or more aspects of the techniques are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example vehicle configured to perform various aspects of the occupant awareness techniques described in this disclosure.

FIG. 2 is a diagram illustrating a vehicle, which is equipped with an active noise cancellation (ANC) apparatus of this disclosure.

FIG. 3 is a block diagram illustrating an example of an ANC apparatus that includes a feedback ANC filter and an error microphone that is disposed to sense sound produced by a loudspeaker.

FIG. 4A is a block diagram illustrating a finite-impulse-response (FIR) implementation of a feed-forward ANC filter.

FIG. 4B is a block diagram illustrating an alternate implementation of a FIR filter.

FIG. 5 is a block diagram illustrating an infinite-impulse-response (IIR) implementation of a filter.

FIG. 6 is a block diagram illustrating an ANC apparatus that may be configured to perform various aspects of the limited ANC output techniques described in this disclosure.

FIG. 7 is a block diagram illustrating the limit control block shown in the example of FIG. 6 in more detail.

FIG. 8 is a is a graph showing similarity measurement information between one particular type of engine-external noise (namely, the audio data of vehicle occupant(s) speaking), with the RPM measurements received from the PCM of the engine of the vehicle.

FIG. 9 is a graph showing similarity measurement information between one particular type of engine-external noise (namely, the audio data of vehicle occupant(s) speaking), with the RPM measurements received from the PCM of the engine of the vehicle.

FIG. 10 is a graph showing similarity measurement information between one particular type of engine-external noise (namely, the audio data of vehicle occupant(s) speaking), with the RPM measurements received from the PCM of the engine of the vehicle.

FIG. 11 is a graph showing similarity measurement information between one particular type of engine-external noise (namely, the audio data of an ambulance, such as the siren of the ambulance), with the RPM measurements received from the PCM of the engine of the vehicle.

FIG. 12 is a graph showing similarity measurement information between one particular type of engine-external noise (namely, the audio data of a siren of a police car), with the RPM measurements received from the PCM of the engine of the vehicle.

FIG. 13 is a block diagram illustrating an ANC apparatus that may be configured to perform various aspects of the limited ANC output techniques described in this disclosure.

FIG. 14 is a flowchart illustrating an example process by which an ANC apparatus may implement one or more of the enhanced ANC technologies of this disclosure.

### DETAILED DESCRIPTION

The devices, apparatuses, systems and methods disclosed herein may be applied to or integrated within a variety of devices. Examples of computing devices include in-vehicle audio systems, cellular phones, smartphones, headphones, video cameras, audio players (e.g., Moving Picture Experts Group-1 (MPEG-1) or MPEG-2 Audio Layer 3 (MP3) players), video players, audio recorders, desktop computers/laptop computers, personal digital assistants (PDAs), gaming systems, etc. For purposes of discussion, this disclosure discusses the systems with respect to their integration into in-vehicle audio systems.

A computing device or communication device may operate in accordance with certain industry standards, such as International Telecommunication Union (ITU) standards and/or Institute of Electrical and Computing Engineers (IEEE) standards (e.g., Wireless Fidelity or “Wi-Fi” standards such as 802.11a, 802.11b, 802.11g, 802.11n and/or 802.11ac). Other examples of standards that a communication device may comply with include IEEE 802.16 (e.g., Worldwide Interoperability for Microwave Access or “WiMAX”), Third Generation Partnership Project (3GPP), 3GPP Long Term Evolution (LTE), Global System for Mobile Telecommunications (GSM) and others (where a communication device may be referred to as a User Equipment (UE), NodeB, evolved NodeB (eNB), mobile device, mobile station, subscriber station, remote station, access terminal, mobile terminal, terminal, user terminal, subscriber unit, etc., for example).

While some of the devices, apparatuses, systems and methods disclosed herein may be described in terms of one or more standards, the techniques should not be limited to the scope of the disclosure, as the devices, apparatuses, systems and methods may be applicable to many systems and/or standards. It should be noted that some communication devices may communicate wirelessly and/or may communicate using a wired connection or link. For example, some communication devices may communicate with other devices using an Ethernet protocol. The devices, apparatuses, systems and methods disclosed herein may be applied to communication devices that communicate wirelessly and/or that communicate using a wired connection or link.

As used herein, the terms, “cancel,” “cancellation” and other variations of the word “cancel” may or may not imply a complete cancellation or suppression of a signal. For example, if a first signal “cancels” a second signal, the first signal may interfere with the second signal in an attempt to reduce the second signal in amplitude. The resulting signal may or may not be reduced or completely cancelled. Thus, at several instances of this disclosure, the second signal is referred to as being “cancelled” if the first signal, which is played back currently with the occurrence of the second signal, effectively renders the second signal undetectable to the human ear, due to the resulting amplitude reduction. Further details of ANC may be found in pending U.S. Pat. No. 9,402,132, issued on 26 Jul. 2016.

As used herein, the terms “circuit,” “circuitry” and other variations of the term “circuit” may denote a structural element or component. For example, circuitry can be an aggregate of circuit components, such as a multiplicity of integrated circuit components, in the form of processing and/or memory cells, units, blocks and the like. Processing circuitry may include fixed function circuitry, programmable processing circuitry, or various combinations of fixed function circuitry and programmable processing circuitry. Moreover, the terms “processors” or “processing circuitry,” as used herein include one or more digital signal processors (DSPs), general purpose microprocessors, application specific integrated circuits (ASICs), field programmable logic arrays (FPGAs), or other equivalent integrated circuits or discrete logic circuitry.

Traditionally, static or non-adaptive active noise control (ANC) consists of a filtering operation and requires a noise signal input. Conventional, non-adaptive ANC may be applied to the audio data played back by an in-vehicle audio system, such as an audio system that is coupled to or forms a part of an in-vehicle infotainment system. In one example of feed-forward ANC in an in-vehicle context, error microphones may be positioned at different locations within a vehicle cabin. A speaker system, which includes one or more loudspeakers (e.g., such as full-range driver-based loudspeakers, individual loudspeakers that include multiple range-specific dynamic drivers, or loudspeakers that include a single dynamic driver such as a tweeter or a woofer) are customarily positioned at various locations in the vehicle cabin, as well.

ANC systems of the in-vehicle audio system may use, as an input to the ANC process, noise signals provided by the error microphones. In turn, the ANC systems may generate a noise-canceling signal using the noise signals received from the error microphones. In various examples, the ANC system may generate a noise-canceling signal that has the same amplitude as the noise signal, but with an inverted phase with respect to the noise signal. The ANC system may add the noise-canceling signal to the loudspeaker feeds, such as by the use of a mixer. When played back over the in-cabin loudspeakers of the vehicle, the noise-canceling signal interferes with the noise that was also captured by the error microphones, and the interference effectively renders the noise less audible or inaudible to the human ear.

Adaptive ANC (AANC) consists of both a filtering operation and an adaptation operation. Typically, an adaptive algorithm for feed-forward (FF) ANC requires an error signal input, which measures the remaining noise signal at a “quiet zone” (e.g., in this case, the in-vehicle cabin). Thus, traditional adaptive FF ANC may require two input signals. One input signal may include external noise and the other input signal includes an error signal (from the error microphones, for example). The filtering operation may require only the noise signal input. However, the adaptation operation may require both the noise signal input and the error signal input.

ANC or adaptive ANC (AANC) may, in some instances, increase the gain of the audio signal to be output by the speaker due to the cancellation effects of applying ANC or AANC. That is, when external noise levels are high, the resulting ANC/AANC signal may also have high levels (meaning a higher gain in comparison to the original signal). When input noise levels exceed some extreme level A (which are often expressed in terms of acceptable decibel (dB) levels for an average listening duration, and “extreme” being typically defined as resulting in some non-minimal loss of hearing when exposed to these dB levels over the average listening duration), the ANC/AANC audio signal may exceed a level B, which is over some threshold C (where this threshold is again expressed in terms of dB over an average listening duration, and this threshold is set to avoid non-minimal loss of hearing when exposed to these threshold dB levels over the average listening duration). The resulting ANC/AANC audio signals may result in potential issues, such as saturation in digital systems, speaker damage by excessive excursion and human hearing damage.

In one example of generic adaptive ANC processing, the error microphone captures an error signal e(n). In generic adaptive ANC processing, an adaptive algorithm minimizes the error signal e(n), which converges an adaptive filter W(z) to an optimal solution. Converging the adaptive filter may be referred to as an iterative convergence or training process. In this example,

$$W ( z ) = \frac{- P ( z )}{S ( z )} ,$$

where P(z) is a first transfer function (e.g., primary path transfer function) and S(z) is a second transfer function (e.g., secondary path transfer function).

Another example of traditional adaptive ANC processing is called filtered-x least mean squares (FxLMS) adaptive ANC processing. This approach also uses an error microphone to capture an error signal e(n). An LMS algorithm uses the captured error signal e(n) to train or converge the adaptive filter W(z).

However, the error signal e(n) may include temporary noise disturbances that originate at some source external to the vehicle's engine. For instance, the error microphones may capture the sound of an ambulance siren as an ambulance, moving in the opposite direction of the vehicle, is briefly positioned next to the vehicle. In turn, the ANC system may converge the adaptive filter W(z) with the updated error signal e(n) that incorporates the noise captured from the passing ambulance siren. When the updated noise-canceling signal is played back, the noise-canceling signal may include the phase-inverted (or “antiphase”) version of the ambulance siren. However, from a user audibility perspective, the antiphase siren signal may be played back in the absence of the corresponding siren noise, as the ambulance may now be out of earshot of the vehicle's occupants.

The techniques described in this disclosure enable the ANC/AANC system of an in-vehicle audio system to distinguish between engine noise (which is to be canceled by way of a noise-canceling signal), and engine-external noise (which, in several situations, can be disregarded during generation of the noise-canceling signal) in the error signal e(n). The in-vehicle ANC systems of this disclosure, in turn, downplay or even disregard certain engine-external noises in generating the resulting noise-canceling signal.

In this way, ANC systems of this disclosure may provide a more user-friendly ANC experience, in that the played-back noise-canceling signal does not include certain antiphase audio components that no longer have a corresponding noise component with which to interfere. Thus, in-vehicle ANC systems of this disclosure may reduce or eliminate unwanted antiphase audio components of the noise-canceling signal, while preserving the engine noise-canceling aspects of the existing noise cancellation technology.

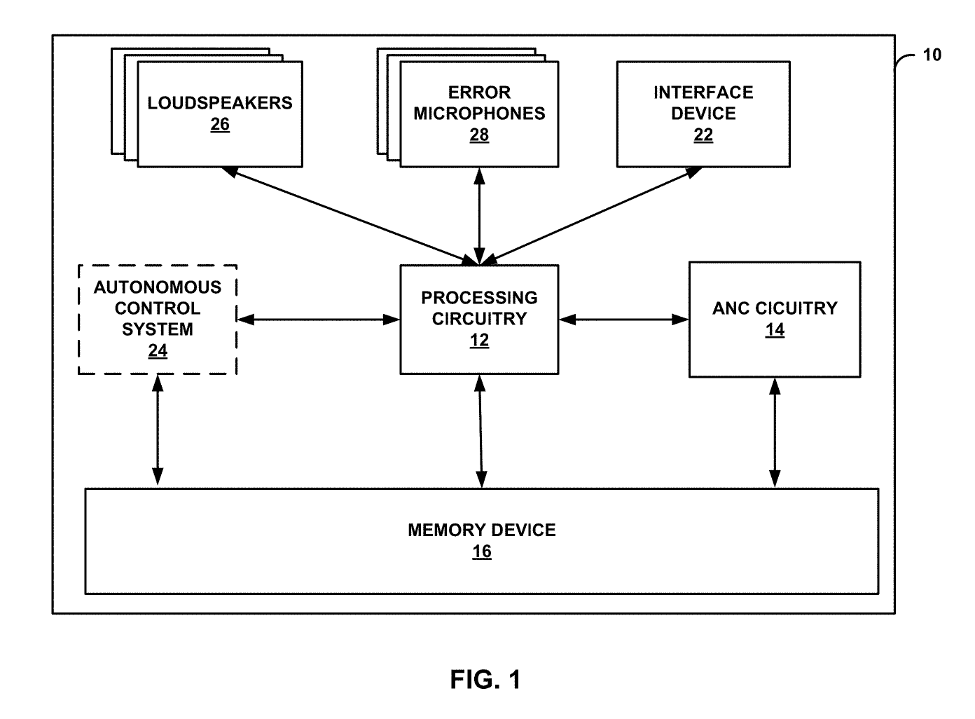

FIG. 1 is a block diagram illustrating an example vehicle 10 configured to perform various aspects of the occupant awareness techniques described in this disclosure. Vehicle 10 is assumed in the description below to be an automobile. However, the techniques described in this disclosure may apply to any type of vehicle capable of conveying occupant(s) in a cabin, such as a bus, a recreational vehicle (RV), a semi-trailer truck, a tractor or other type of farm equipment, a train car, a plane, a personal transport vehicle, and the like.

In the example of FIG. 1, the vehicle 10 includes processing circuitry 12, an ANC circuitry 14, and a memory device 16. In some examples, the processing circuitry 12 and the ANC circuitry 14 may be formed as an integrated circuit (IC). For example, the IC may be considered as a processing chip within a chip package, and may be a system-on-chip (SoC). As illustrated in FIG. 1, the vehicle 10 may also optionally include an autonomous control system 24. The optional nature of autonomous control system 24 is shown by way of dashed-line borders, and in different implementations, autonomous control 24 may implement different levels of autonomy with respect to the driving capabilities of vehicle 10

Examples of the processing circuitry 12 and the ANC circuitry 14 include, but are not limited to, one or more digital signal processors (DSPs), general purpose microprocessors, application specific integrated circuits (ASICs), field programmable logic arrays (FPGAs), fixed function circuitry, programmable processing circuitry, any combination of fixed function and programmable processing circuitry, or other equivalent integrated circuitry or discrete logic circuitry. Processing circuitry 12 may be the central processing unit (CPU) of the vehicle 10. In some examples, the ANC circuitry 14 may be specialized hardware that includes integrated and/or discrete logic circuitry that provides the ANC circuitry 14 with parallel processing capabilities.

Processing circuitry 12 may execute various types of applications, such as various occupant experience related applications including climate control interfacing applications, entertainment and/or infotainment applications, cellular phone interfaces (e.g., as implemented using Bluetooth® links), stock trackers, vehicle functionality interfacing applications, web or directory browsers, or other applications that enhance the occupant experience within the confines of the vehicle 10. The memory device 16 may store instructions for execution of the one or more applications. As shown, memory device 16 implements a command buffer 20. The processing circuitry 12 may store command information to the command buffer 20.

Memory device 16 may include, be, or be part of the total memory for vehicle 10. The memory device 16 may comprise one or more computer-readable storage media. Examples of the memory device 16 include, but are not limited to, a random access memory (RAM), an electrically erasable programmable read-only memory (EEPROM), flash memory, or other medium that can be used to carry or store desired program code in the form of instructions and/or data structures and that can be accessed by a computer or one or more processors.

In some aspects, the memory device 16 may include instructions that cause the processing circuitry 12 to perform the functions ascribed in this disclosure to processing circuitry 12. Accordingly, the memory device 16 may be a computer-readable storage medium having instructions stored thereon that, when executed, cause one or more processors (e.g., the processing circuitry 12) to perform various functions.

Memory device 16 is a non-transitory storage medium. The term “non-transitory” indicates that the storage medium is not embodied in a carrier wave or a propagated signal. However, the term “non-transitory” should not be interpreted to mean that the memory device 16 is non-movable or that its contents are static. As one example, memory device 16 may be removed from vehicle 10, and moved to another device. As another example, memory, substantially similar to memory device 16, may be inserted into one or more receiving ports of the vehicle 10. In certain examples, a non-transitory storage medium may store data that can, over time, change (e.g., in RAM).

As further shown in the example of FIG. 1, the vehicle 10 may include an interface device 22, multiple error microphones 28, and one or more functional units 26. In some examples, interface device may include one or more microphones that are configured to capture audio data of spoken commands provided by occupants of vehicle 10. In some examples, interface device may include an interactive input/output display device, such as a touchscreen. For instance, display devices that can form a portion of the interface device 22 may represent any type of passive screen on which images can be projected, or an active screen capable of projecting images (such as a light emitting diode (LED) display, an organic LED (OLED) display, liquid crystal display (LCD), or any other type of active display), with input-receiving capabilities built in. Although shown as a single device in FIG. 1 for ease of illustration, the interface device 22 may include multiple user-facing devices that are configured to receive input and/or provide output. In various examples, the interface device 22 may include displays in wired or wireless communication with vehicle 10, such as a heads-up display, a head-mounted display, an augmented reality computing device (such as “smart glasses”), a virtual reality computing device or display, a laptop computer or netbook, a mobile phone (including a so-called “smartphone”), a tablet computer, a gaming system, or another type of computing device capable of acting as an extension of or in place of a display integrated into the vehicle 10.

The interface device 22 may represent any type of physical or virtual interface with which a user may interface to control various functionalities of the vehicle 10. The interface device 22 may include physical buttons, knobs, sliders or other physical control implements. Interface device 22 may also include a virtual interface whereby an occupant of vehicle 10 interacts with virtual buttons, knobs, sliders or other virtual interface elements via, as one example, a touch-sensitive screen. Occupant(s) may interface with the interface device 22 to control one or more of a climate within vehicle 10, audio playback by vehicle 10, video playback by the vehicle 10, transmissions (such as cellphone calls) through the vehicle 10, or any other operation capable of being performed by vehicle 10.

The interface device 22 may also represent interfaces extended from the vehicle 10 when acting as an extension of or in place of a display integrated into the vehicle 10. That is, the interface device 22 may include virtual interfaces presented via the above noted HUD, augmented reality computing device, virtual reality computing device or display, tablet computer, or any other of the different types of extended displays listed above. The vehicle 10 may include a steering wheel for controlling a direction of travel of the vehicle 10, one or more pedals for controlling a rate of travel of vehicle 10, one or more hand brakes, etc. In some examples, the steering wheel and pedals may be included in a particular in-cabin vehicle zone of the vehicle 10, such as in the driver zone or pilot zone.

In examples where the vehicle 10 includes the autonomous control system 24, the autonomous control system 24 may include various sensors and units, such as a global positioning system (GPS) unit, one or more accelerometer units, one or more gyroscope units, one or more compass units, one or more radar units, one or more LiDaR (which refers to a Light Detection and Ranging) units, one or more cameras, one or more sensors for measuring various aspects of the vehicle 10 (such as a steering wheel torque sensor, steering wheel grip sensor, one or more pedal sensors, tire sensors, tire pressure sensors), and any other type of sensor or unit that may assist in autonomous operation of vehicle 10. In this respect, the autonomous control system 24 may control operation of the vehicle 10 allowing the occupant to participate in tasks unrelated to the operation of the vehicle 10.

The error microphones 28 of the vehicle 10 may represent a microphone array, with at least one microphone positioned in various in-cabin vehicle zones of a cabin of the vehicle 10. In one example, each in-cabin vehicle zone represents an area that typically seats or otherwise accommodates a single occupant. Each of the error microphones 28 may represent a data-input component or a combination of data-input components configured to capture audio data.

The error microphones 28 may capture noise from within the cabin of the vehicle 10. For instance, the error microphones 28 may capture engine noise, or a combination of engine noise and engine-external noise. The error microphones 28 may generate an error signal that the processing circuitry and/or the ANC circuitry 14 may use to implement various user experience-related functionalities. For instance, the ANC circuitry 14 may use the error signal to form noise-canceling components of audio data to be output via the loudspeakers 26 positioned within the cabin of the vehicle 10.

Loudspeakers 26 represent components of the vehicle 10 that reproduce a soundfield based on audio signals provided directly or indirectly by the processing circuitry 12 and/or the ANC circuitry 14. For instance, the loudspeakers 26 may generated pressure waves based on one or more electrical signals received from the processing circuitry 12 and/or the ANC circuitry 14. The loudspeakers 26 may include various types of speaker hardware, including full-range driver-based loudspeakers, individual loudspeakers that include multiple range-specific dynamic drivers, or loudspeakers that include a single dynamic driver such as a tweeter or a woofer.

The ANC circuitry 14 may be configured to perform one or more of the enhanced ANC techniques of this disclosure. For instance, the ANC circuitry 14 may be configured to alter a convergence between multiple ANC filters, to mitigate or potentially eliminate noise-canceling sounds that are based on engine-external noise. As such, the ANC circuitry 14 may be coupled to the error microphones 28, and the ANC circuitry 14 may be configured, according to aspects of this disclosure, to process audio data received from the error microphones 28 to determine a distinction between the engine-external noise and the engine noise, to alter, based on the distinction determined between the engine-external noise and the engine noise, a convergence between two or more ANC filters to form altered-convergence ANC filtering coefficients, and to use the altered-convergence ANC filtering coefficients to the processed audio data to add a noise-canceling component to the processed audio data to form noise-canceled audio data. Loudspeakers 26 are coupled to the ANC circuitry 14, and are configured to output the audio data processed by the ANC circuitry 14.

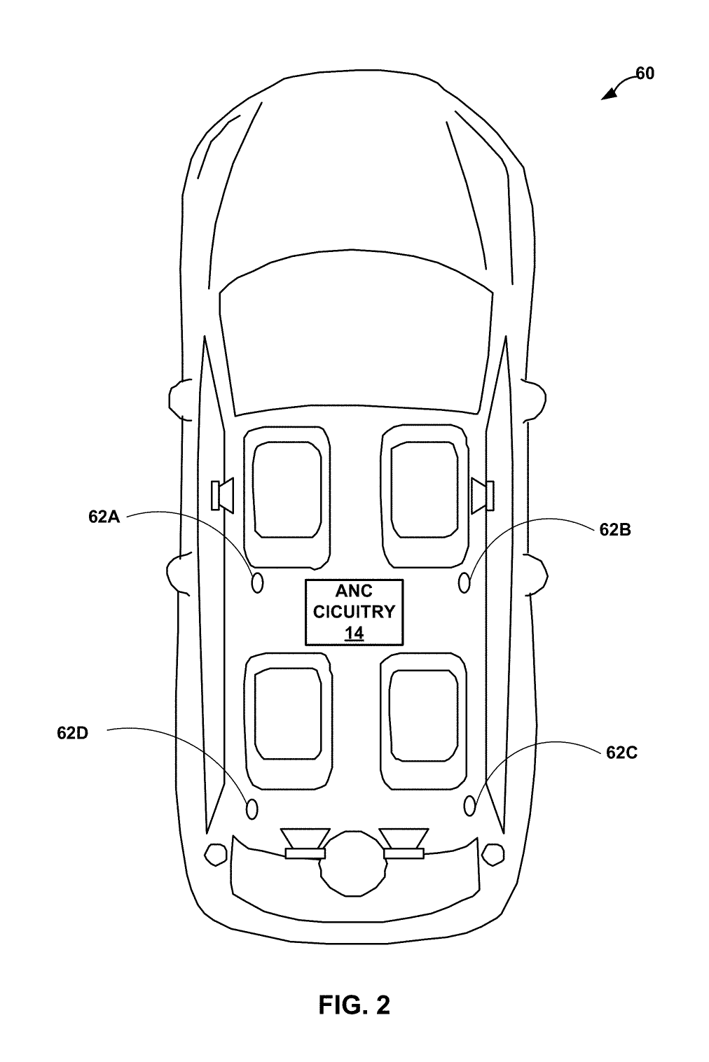

FIG. 2 is a diagram illustrating a vehicle 60, which is equipped with the ANC circuitry 14 that is illustrated in FIG. 1 and described above. The cabin of vehicle 60 is equipped with four error microphones 62A-62D (collectively, error microphones 62). While FIG. 2 shows vehicle 60 as being equipped with four error microphones for purposes of example, it will be appreciated that vehicle 60 may be equipped with a different number of microphones in different examples. It will also be appreciated that FIG. 2 illustrates possible positions for error microphones 62, and that other positions are permissible for error microphones within the cabin of vehicle 60.

According to existing technology, in-vehicle ANC systems are designed to address the change in exhaust noise whenever the vehicle 60 is operating in fuel economy mode (ECO mode) or in four-cylinder mode. The existing ANC systems rely on four microphones embedded in a headliner to detect the exhaust drone and prompt an onboard frequency generator to create counteracting sound waves through the audio system's speakers and sub-woofer. This helps keep the vehicle quiet at highway speeds. The ANC module of existing systems performs the creation of signals appropriate to cancel engine order related vehicle noises from the engine. It creates these signals in proportion to the engine RPM plus any other needed input.

The ANC circuitry 14 of FIG. 2 may include, be, or be part of an in-vehicle ANC system of vehicle 60, such as ANC circuitry implemented within an in-vehicle audio system of vehicle 60. The ANC circuitry 14 may be configured to perform various functionalities described herein, such as distinguishing between engine noise and engine-external noise to form antinoise or noise-canceling signal SY10 to exclude anti-noise audio components resulting from engine-external noises. As described above, the techniques of this disclosure that the ANC circuitry 14 may address user experience diminishments that result from implementing ANC with respect to all noise captured by error microphones 62. For instance, in accordance with existing ANC technologies that are aimed at implementing interference that would effectively drown out or “zero out” the noise captured by error microphones 62, the ANC circuitry 14 would generate noise-canceling signal SY10 using equal-amplitude, inverted-phase audio data corresponding to all noise captured by error microphones 62. Thus, according to existing ANC technology, occupants of vehicle 60 may be subjected to the playback of noise-canceling audio signals that include audio components that are generated from temporary noises that no longer need to be canceled out.

By implementing the ANC-related enhancements of this disclosure, the ANC circuitry 14 may process audio data received from the error microphones 62 to determine a distinction between engine noise (caused by an engine of vehicle 60) and engine-external noise (e.g., caused by non-engine sources). Examples of engine-external noise may originate within the cabin of vehicle 60 (e.g., due to occupants talking, using a cellular phone on speaker mode, etc.), from an interface between vehicle 60 and external entities (e.g., vehicle 60 going over a speed bump or a reflective stud), or from sources that are entirely external to vehicle 60 (e.g., a police car siren or ambulance siren in the vicinity of vehicle 60). A general characteristic of these engine-external noises is that the engine-external noises tend to be temporary, and, in many cases, do not warrant alteration of the noise-canceling signal SY10.

According to the techniques described herein, the ANC circuitry 14 may form altered-convergence ANC filtering coefficients based on the distinction determined between the engine noise of vehicle 60 and the engine-external noise. As an example, based on the distinction, the ANC circuitry 14 may alter the convergence between two or more ANC filters to form the altered-convergence ANC filtering coefficients. For instance, the ANC circuitry 14 may slow the convergence between the ANC filters. By slowing the convergence of the ANC filters, the ANC circuitry 14 may reduce or potentially eliminate the generation of antinoise audio data that targets the engine-external noise. To slow the convergence of the ANC filters, the ANC circuitry 14 may alter (e.g., reduce) a step-size of a learning algorithm that the ANC circuitry 14 implements with respect to the formation of the noise-canceling signal SY10.

The altered-convergence ANC filtering coefficients, when applied, represent an ANC filtering mechanism that the ANC circuitry 14 may implement in order to apply the slowed-convergence relationship between the ANC filters. That is, the ANC circuitry 14 may slow the convergence of the ANC filters to form a new set of filtering coefficients, referred to herein as the “altered-convergence ANC filtering coefficients.” That is, the altered-convergence filtering coefficients represent a result of the ANC circuitry 14 implementing one or more techniques of this disclosure to alter (e.g., slow) the convergence of the ANC filters. Moreover, the altered-convergence filtering coefficients of this disclosure, when applied by the ANC circuitry 14, enable the ANC circuitry 14 to reduce or potentially eliminate the generation of antinoise audio data that would otherwise target engine-external (and therefore, largely ephemeral) noise.

In some examples, the ANC circuitry 14 may communicate with a powertrain control module (PCM) of the engine of vehicle 60 to obtain metrics that reflect revolutions per unit time (e.g., revolutions per minute, denoted as ‘RPM’) measurements taken by the PCM. In turn, the ANC circuitry 14 may generate various signals based on a sine wave frequency of a current RPM measurement, or most recently-timestamped RPM measurement obtained from the PCM. It will be appreciated that the RPM measurements of the engine of vehicle 60 may represent a dynamic, or changing, measurement, as the operation of the engine can vary in terms of gear shifts, speed changes, etc. The engine-external noise captured by error microphones 62 may also represent a dynamic data set, because the engine-external noise is often temporary, as discussed above.

The ANC circuitry 14 may determine a similarity measure between the signals that were generated based on the sine wave frequency of the RPM measurement(s) and the error signal e(n) received via error microphones 62. Using the similarity measure, the ANC circuitry 14 may generate noise-canceled audio data, such as a combination of audio playback from the infotainment system and noise-canceling signal SE10. For example, signals that the ANC circuitry 14 generates using the sine wave frequency of the RPM measurement may be a set (e.g., pair) of time-domain signals. In this example, the ANC circuitry 14 may determine the similarity measure by determining any one or more of a spectral coherence, a time correlation, or a magnitude-squared coherence between the time-domain signals.

As discussed, above, the ANC circuitry 14 may reduce the step-size of a learning algorithm that the ANC circuitry 14 implements with respect to the error signal e(n) received from the error microphones 62. For instance, the ANC circuitry 14 may reduce the step-size of a learning algorithm that is based on the RPM measurements obtained from the PCM of the engine of the vehicle 60.

Although not shown in the example of FIG. 2 for ease of illustration purposes only, it will be appreciated that the cabin of the vehicle 60 may also be equipped with one or more system-control microphones. Occupants of the cabin of the vehicle 60 may operate one or more functional units of the vehicle 60 by providing spoken commands via the system-control microphones. The ANC circuitry 14 may suppress any audio data captured by the system-control microphones that matches or substantially matches the audio data of noise-cancellation signal SE10 or any other antinoise audio components output by a speaker system of the vehicle 60. The suppression may correspond to echo cancellation functionalities that the ANC circuitry 14 implements with respect to the audio data captured by the system-control microphones.

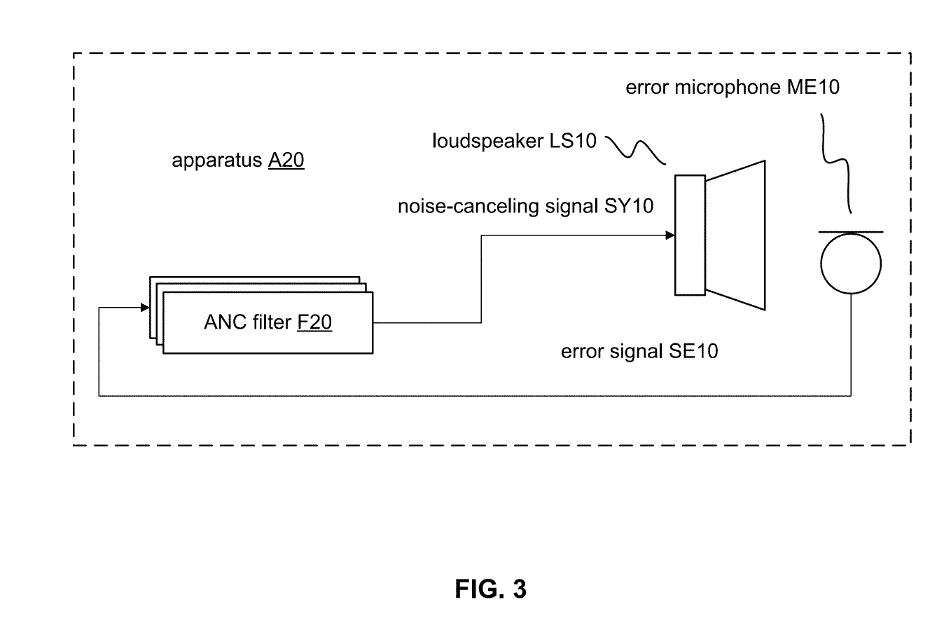

FIG. 3 is a block diagram illustrating an example A20 of an ANC apparatus that includes one or more feedback ANC filters F20 and an error microphone ME10 that is disposed to sense sound at a user's ear canal, including sound (e.g., an acoustic signal based on noise-canceling signal SY10) produced by loudspeaker LS10. Filter(s) F20 is arranged to receive an error signal SE10 that is based on a signal produced by error microphone ME10 and to produce a corresponding antinoise or noise-canceling signal SY10.

In some examples, the ANC filter (e.g., filter F10, filter(s) F20) is configured to generate the noise-canceling signal SY10 such that the noise-canceling signal SY10 is matched with the acoustic noise in amplitude and opposite or inverted with respect to the acoustic noise in phase. Signal processing operations such as time delay, gain amplification, and equalization or lowpass filtering may be performed to achieve optimal noise cancellation. In some instances, the ANC filter may be configured to high-pass filter the signal (e.g., to attenuate high-amplitude, low-frequency acoustic signals). Additionally or alternatively, the ANC filter may be configured to low-pass filter the signal (e.g., such that the ANC effect diminishes going toward higher frequencies). Because the antinoise signal should be available by the time the acoustic noise travels from the microphone to the actuator (i.e., loudspeaker LS10), the processing delay caused by the ANC filter should not exceed a very short time (typically about thirty to sixty microseconds).

Filter(s) F20 include a digital filter, such that ANC apparatus A20 may be configured to perform analog-to-digital conversion on the signal produced by reference microphone MR10 to produce error signal SE10 in digital form. Similarly, filter(s) F20 includes a digital filter, such that ANC apparatus A20 may be configured to perform analog-to-digital conversion on the signal produced by error microphone ME10 to produce error signal SE10 in digital form. Examples of other preprocessing operations that may be performed by the ANC apparatus upstream of the ANC filter in the analog and/or digital domain include spectral shaping (e.g., low-pass, high-pass, and/or band-pass filtering), echo cancellation (e.g., on error signal SE10), impedance matching, and gain control. For example, the ANC apparatus (e.g., apparatus A20) may be configured to perform a high-pass filtering operation (e.g., having a cutoff frequency of 50, 100, or 200 Hz) on the signal upstream of the ANC filter.

The ANC apparatus A20 may also include a digital-to-analog converter (DAC) arranged to convert noise-canceling signal SY10 to analog form upstream of loudspeaker LS10. In some instances, the ANC apparatus may be configured to mix a desired sound signal with the antinoise or noise-canceling signal SY10 (in either the analog or digital domain) to produce an audio output signal for reproduction by loudspeaker LS10. Examples of such desired sound signals include a received (i.e. far-end) voice communications signal, a music or other multimedia signal, and a sidetone signal.

According to various aspects of this disclosure, the ANC apparatus A20 may slow the convergence of the ANC filter(s) F20 with other ANC filters, based on a determination that the error signal received from error microphone ME 10 shows a variance from the engine noise that is greater than a similarity measure between the engine noise and the error signal received from the error microphone ME 10. For instance, the ANC apparatus A20 may slow the convergence of filter coefficients associated with the ANC filter(s) F20 and the other ANC filter(s) in order to reduce or potentially eliminate the antinoise audio components associated with engine-external noise received from the error microphone ME10.

The altered-convergence ANC filtering coefficients, when applied, represent an ANC filtering mechanism that the ANC apparatus A20 may implement in order to apply the slowed-convergence relationship between the ANC filters. That is, the ANC apparatus A20 may slow the convergence of the ANC filters (e.g., by reducing the step-size of a learning algorithm associated therewith) to form a new set of filter coefficients, referred to herein as the “altered-convergence ANC filtering coefficients.” That is, the altered-convergence filtering coefficients represent a result of the ANC apparatus A20 implementing one or more techniques of this disclosure to alter (e.g., slow) the convergence of the ANC filters. Moreover, the altered-convergence filtering coefficients of this disclosure, when applied by the ANC apparatus A20, enable the ANC apparatus A20 to reduce or potentially eliminate the generation of antinoise audio data that would otherwise target engine-external (and therefore, largely ephemeral) noise. That is, the altered-convergence filtering coefficients of this disclosure, when applied by the ANC apparatus A20, enable the ANC apparatus A20 to avoid generating antinoise audio that targets noise (e.g., engine-external noise) that is likely to have ceased prior to the any updating of the antinoise data under existing ANC technology.

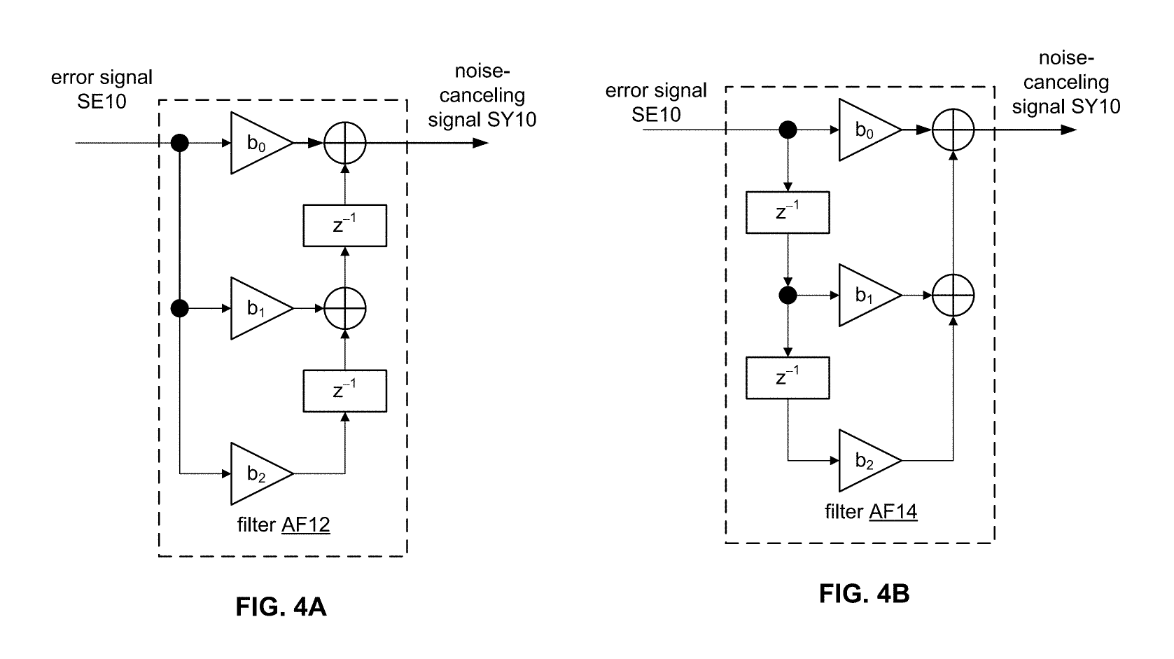

FIG. 4A is a block diagram illustrating a finite-impulse-response (FIR) implementation AF12 of one or more feedforward ANC filters. In this example, filter AF12 has a transfer function B(z)=b₀+b₁*z⁻¹+b₂*z⁻² that is defined by the values of the filter coefficients (i.e., feedforward gain factors b₀, b₁, and b₂). Although a second-order FIR filter is shown in this example, an FIR implementation of the ANC feedforward filter(s) may include any number of FIR filter stages (i.e., any number of filter coefficients), depending on factors such as maximum allowable delay. For a case in which error signal SE10 is one bit wide, each of the filter coefficients may be implemented using a polarity switch (e.g., an XOR gate). The error signal SE10 may include engine-external noises that ANC apparatus A20 may disregard in forming the noise-canceling signal SY10 by slowing a convergence between various applied ANC filters.

FIG. 4B is a block diagram illustrating an alternate implementation AF14 of FIR filter AF12. Feedback ANC filter(s) AF20 may be implemented as an FIR filter according to the same principles discussed above with reference to FIG. 4A. The error signal SE10 may include engine-external noises that ANC apparatus A20 may disregard in forming the noise-canceling signal SY10 by slowing a convergence between various applied ANC filters.

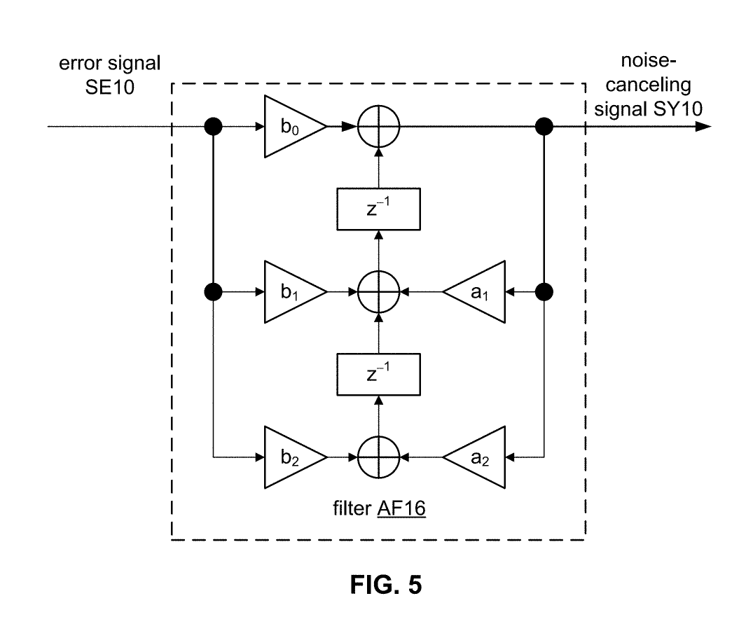

FIG. 5 is a block diagram illustrating an infinite-impulse-response (IIR) implementation AF16 of filter AF16. In this example, filter AF16 has the transfer function B(z)/(1−A(z))=(b₀+b₁*z⁻¹+b₂*z⁻²)/(1−a₁*z⁻¹−a₂*z⁻²) that is defined by the values of the filter coefficients (i.e., feedforward gain factors b₀, b₁, and b₂ and feedback gain factors a₁ and a₂). Although a second-order IIR filter is shown in this example, an IIR implementation of filter AF16 may include any number of filter stages (i.e., any number of filter coefficients) on either of the feedback side (i.e., the denominator of the transfer function) or the feedforward side (i.e., the numerator of the transfer function), depending on factors such as maximum allowable delay. For a case in which error signal SE10 is one bit wide, each of the filter coefficients may be implemented using a polarity switch (e.g., an XOR gate). Feedback ANC filter AF16 may be implemented as an IIR filter according to the same principles discussed above with reference to FIG. 5. Any one or more of filter(s) F20 may also be implemented as a series of two or more FIR and/or IIR filters.

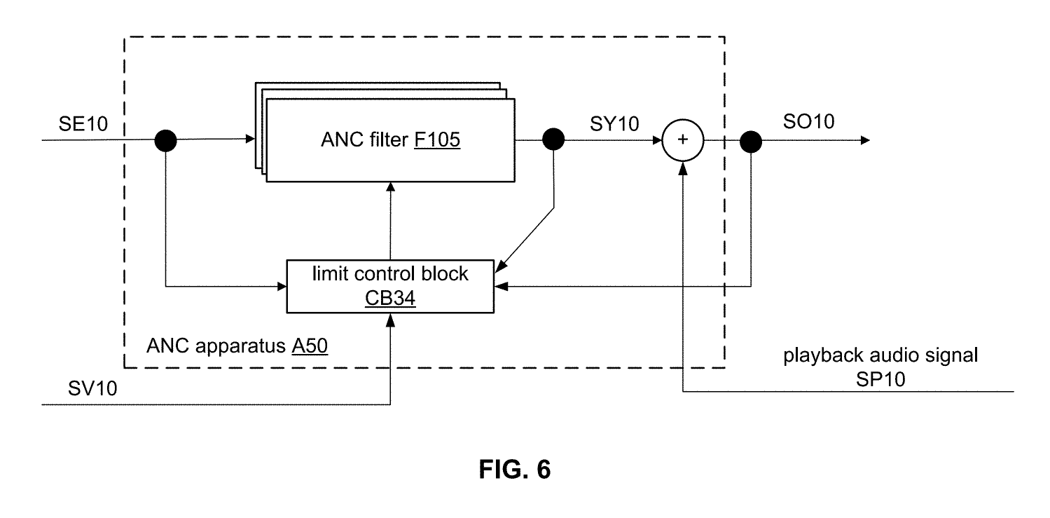

FIG. 6 is a block diagram illustrating an ANC apparatus A50 that may be configured to perform various aspects of the limited ANC output techniques described in this disclosure. ANC apparatus A50 may represent one example of above described ANC apparatus A20 in that ANC apparatus A50 includes one or more ANC filters F105, which may be similar or substantially similar to ANC filter(s) F20 of ANC apparatus A20. Although not shown in the example of FIG. 6, ANC apparatus A50 may include or otherwise be coupled to a loudspeaker similar to loudspeaker LS10 shown in the example of FIG. 3, and a reference microphone similar to reference microphone MR 10 also shown in the example of FIG. 3.

According to various aspects of this disclosure, the ANC apparatus A20 may slow the convergence of the ANC filter(s) F20 with other ANC filters, based on a determination that the error signal received from error microphone ME 10 shows a variance from the engine noise that is greater than a similarity measure between the engine noise and the error signal received from the error microphone ME 10. For instance, the ANC apparatus A20 may slow the convergence of filter coefficients associated with the ANC filter F20 and the other ANC filter(s) in order to reduce or potentially eliminate the antinoise audio components of the noise-canceling signal SY10 associated with engine-external noise received from the error microphone ME10.

In the example of FIG. 6, ANC apparatus A50 also includes a limit control block CB34, which may represent a unit configured to perform various aspects of the techniques described in this disclosure. Limit control block CB34 may receive, retrieve or otherwise determine an error signal SE10 obtained via a reference microphone, a voice audio signal SV10 obtained via a voice microphone (which may be different than the reference microphone), an active noise cancelled version of error signal SE10 (which may be referred to as “active noise cancelled audio signal SY10”) and a mixed output audio signal SO10 (which may represent an audio signal resulting from mixing active noise cancelled audio signal with playback audio signal SP10). Playback audio signal SP10 may represent an audio signal intended for playback via ANC apparatus A50 or some other device. Examples of playback audio signal SP10 represent so-called “desired” audio signals, such as music or other multi-media audio signals and voice audio signals. Playback audio signal SP10 may represent a “desired” audio signal in that the generally local noise-free quality of the audio signal (meaning that the playback audio signal SP10 may still have noise interjected purposefully, such as with music or multimedia audio signals, or not-locally, such as in a voice audio signal received from another communication device).

Limit control block CB34 may receive these signals SE10, SV10, SY10, and SO10 and first perform noise estimation with respect to one or more of the signals SE10, SV10, SY10 and SO10. While described as performing noise estimation, limit control block CB34 may, in some instances, not perform noise estimation, where such noise estimation is performed by a dedicated noise estimation block. In these instances, limit control block CB 34 may receive an estimated noise level from the noise estimation block, as described in further detail below. In any event, limit control block CB34 may perform noise estimation with respect to one or more of signals SE10, SV10, SY10 and SO10 to determine an estimated noise level. Reference to signals in this disclosure, such as signals SE10, SV10, SY10 and SO10 should be understood to refer to at least a portion of the signals and not necessarily the signal in its entirety.

Continuing, limit control block CB34 may measure loudness of one or more of signals SE10, SV10, SY10 and SO10 over some time period (e.g., usually a multiple of an audio frame duration) using approaches such as average amplitude, peak amplitude, average power or any combination thereof. For example, when performing noise estimation using average amplitude, limit control block CB34 may estimation the average amplitude by {square root over ((ΣX(t)²)/N)} or (Σ|X(t)|)/N, where X(t) represents a function of one or more signals SE10, SV10, SY10 and SO10 over time t, and N refers to the number of samples that form the signal X(t). Limit control block CB34 may estimate the noise level using peak power by computing MAX(|X(t)|), where the MAX(*) function returns a gain value for the sample of the noise signal X(t) having the maximum gain.

Next, limit control block CB34 may compare the estimated noise level to one or more threshold levels (which may also be referred to as “limits” in this disclosure). In some instances, limit control block CB34 may compare the estimated noise level to a single threshold level and, when the estimated noise level is greater than or equal to (or in some implementation is only greater than) the threshold level, dynamically adjust application of ANC filter(s) F105 to error signal SE10. In other words, limit control block CB 34 may dynamically adjust application of active noise cancellation to audio signal SV10 based on the estimated noise level. Limit controller block CB34 may perform this dynamic adjustment by adjusting a gain of ANC filter(s) F105 (e.g., by specifying new filter coefficients for ANC filter(s) F105 that result in less gain for ANC filter(s) F105).

According to various aspects of this disclosure, the ANC apparatus A20 may slow the convergence of the ANC filter(s) F105 with other ANC filters, based on a determination that the error signal received from error microphone ME 10 shows a variance from the engine noise that is greater than a similarity measure between the engine noise and the error signal received from the error microphone ME 10. For instance, the ANC apparatus A20 may slow the convergence of filter coefficients associated with the ANC filter(s) F105 and the other ANC filter(s) in order to reduce or potentially eliminate the antinoise audio components of the noise-canceling signal SY10 associated with engine-external noise received from the error microphone ME10.

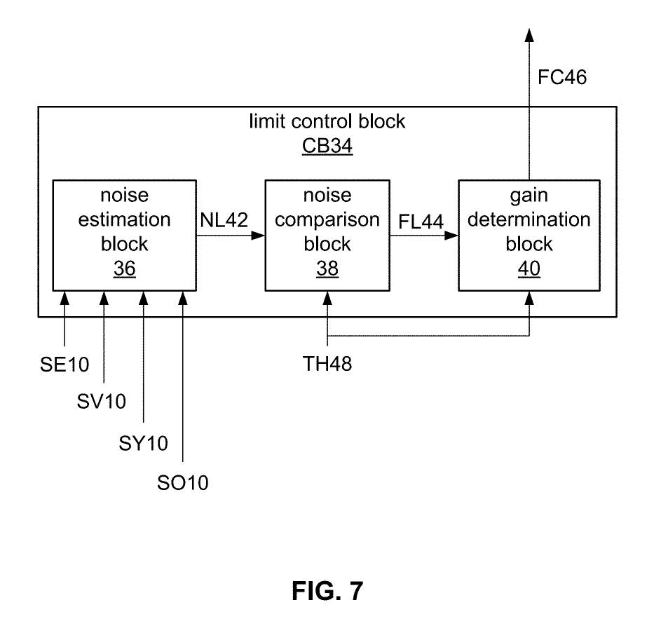

FIG. 7 is a block diagram illustrating limit control block CB34 shown in the example of FIG. 6 in more detail. In the example of FIG. 7, limit control block CB34 includes a noise estimation block 36, a noise comparison block 38 and a gain determination block 40. Noise estimation block 36 may represent a unit configured to estimate a noise level from one or more of signals SE10, SV10, SY10 and SO10. Noise estimation block 36 may estimate the noise level using smoothing functions and/or filtering.

In some instances, noise estimation block 36 may use more than one noise estimation algorithm or model, where each noise estimation model may be configured to estimate different types of noise levels. For example, noise estimation block 36 may include an ambient noise estimation model to estimate a general ambient noise level. In this and other examples, noise estimation block 36 may also include a wind noise estimation model to estimate a particular type of noise, i.e., wind noise, which may require two or more of signals SE10, SV10, SY10 and SO10 to properly estimate the wind noise level. When employing two or more noise estimation algorithms, noise estimation block 36 may form estimated noise level NL42 as a function of the two or more intermediate estimated noise levels output by the two or more noise estimation algorithms. In any event, noise estimation block 36 may output estimated noise level NL42 to noise comparison block 38.

Noise comparison block 38 may represent a unit configured to compare estimated noise level NL42 to a threshold TH48. A user, manufacturer or developer may interface with a user interface presented by ANC apparatus A50 or another device to configure noise comparison block 38 with threshold TH48. In some instances, threshold TH48 may vary based on the type or source of audio signal to be played back (i.e., playback audio signal SP10 shown in the example of FIG. 6). In other words, for a voice call where playback audio signal SP10 represents a voice audio signal, noise comparison block 38 may be configured to compare estimated noise level NL42 to a threshold TH48 specific to voice audio signals, where this threshold TH48 may be higher than a threshold TH48 utilized when the user is attempting to listen to music audio signals. When estimated noise level NL42 equals or exceeds (or, in some instances, only exceeds) threshold TH48, noise comparison block 38 may output a flag FL44 to gain determination block 40, where this flag FL44 may indicate that gain determination block 40 is to reduce gain associated with ANC filter(s) F105. In some instances, this flag FL44 may indicate that gain determination block 40 is to reduce the gain associated with ANC filter(s) F105 to zero (which effectively disables application of ANC filter(s) F105 to error signal SE10). Whether noise comparison block 38 sends a flag FL44 to reduce or set to zero the gain associated with ANC filter(s) F105 may be based on one or more of the type or source of playback audio signals SP10, estimated noise level NL42 or some other criteria or variable.

In some examples, noise comparison block 38 may utilize two or more thresholds TH48. In these and other examples, when estimated noise level NL42 is equal to or exceeds (or, in some instances, only exceeds) a first one of thresholds TH48, noise comparison block 38 may send a first flag FL40 indicating that gain determination block 40 is to reduce, but not disable, the gain associated with ANC filter(s) F105. A second one of thresholds TH48 may be higher than the first one of thresholds TH48. When estimated noise level NL42 is equal to or exceeds (or, in some instances, only exceeds) the second one of thresholds TH48, noise comparison block 38 may output one of flags FL44 that indicates to gain determination block 40 that the gain associated with ANC filter F104 is to be reduced to zero. In this manner, noise comparison block 38 may send one or more flags FL44 to gain determination block 40 to indicate whether gain determination block 40 is to reduce or set to zero the gain associated with ANC filter(s) F105.

Gain determination block 40 represents a unit that may compute a target gain for ANC filter F105 based on a comparison of estimated noise level NL42 to one or more thresholds TH 48 (where this comparison is effectively represented by the one or more of flags FL44). Gain determination block 40 may compute this target gain and then determine one or more filter coefficients FC46 that meet the target gain. Gain determination block 40 may then install these filter coefficients FC46 within ANC filter(s) F105. In this manner, gain determination block 40 may effectively dynamically adjust application of ANC filter(s) F105 to error signal SE10 based on estimated noise level NL42.

Gain determination block 40 may be configured in some instances to incrementally reduce the gain over a given portion of time, e.g., over a series of X frames, where X may be a configurable number set by a user, manufacturer and/or developer. In some instances, the variable X may be configured to have different values depending on the source and/or type of playback audio signal SP10. For example, a user may play a video game that relies on ANC apparatus A50 to improve the experience by reducing or cancelling noise, where the application executing to present the video game may configure X to a number suitable for maintaining a consistent listening experience so as not to disrupt the user's gaming experience. In these and other examples, gain determination block 40 may reduce the gain by some percentage each frame of the X frames, generating filter coefficients FC46 and installing these filter coefficients FC 46 in ANC filter(s) F105 prior to processing the next frame of the X frames.

Gain determination block 40 may, in these and other examples, also compute the target gain as a function of estimated noise level NL42 and threshold TH48. That is, gain determination block 40 may, in these and other examples, compute the target gain as a difference between estimated noise level NL42 and threshold TH48. In some examples, gain determination block 40 may compute the target gain as a function of estimated noise level NL42. In other words, gain determination block 40 may utilize one or more mathematical functions using estimated noise level NL42 as a variable in these one or more functions to compute the target gain. In some examples, gain determination block 40 may use estimated noise level NL42 as a key into a look-up table (LUT), which may return the target gain.

Noise estimation block 36 may continue to receive signals SE10, SV10, SY10 and SO10 and determine estimated noise level NL42. Noise estimation block 36 may output these recently updated estimated noise levels to noise comparison block 38, which may output one or more flags FL44 in the manner described above. Gain determination block 40 may then continue to dynamically (or, in other words, automatically) adjust application of ANC filter(s) F105 based on these flags 44, thresholds 48 and/or estimated noise level 42.

Over time, the ambient noise, background noise, wind noise or other environmental noise may decrease in volume (e.g., a moving environmental noise, such as sirens on a moving vehicle) or cease entirely, at which point noise estimation block 36 may determine a recently updated estimated noise level 42 that is lower than thresholds TH48. When estimated noise level 42 is less than each of the one or more applicable thresholds TH48, noise comparison block 38 may output one or more flags FL44 indicating that gain determination block 40 is to return to a static form of ANC filter(s) F105. Gain determination block 40 may store or otherwise maintain original filter coefficients FC 46 to be used when limiting application of ANC filter(s) F105 is no longer desired or necessary. Gain determination block 40 may retrieve these filters coefficients FC46 and install these filter coefficients FC46 in ANC filter(s) F105 to thereby dynamically readjust application of ANC filter(s) F105 to its originally configured state.

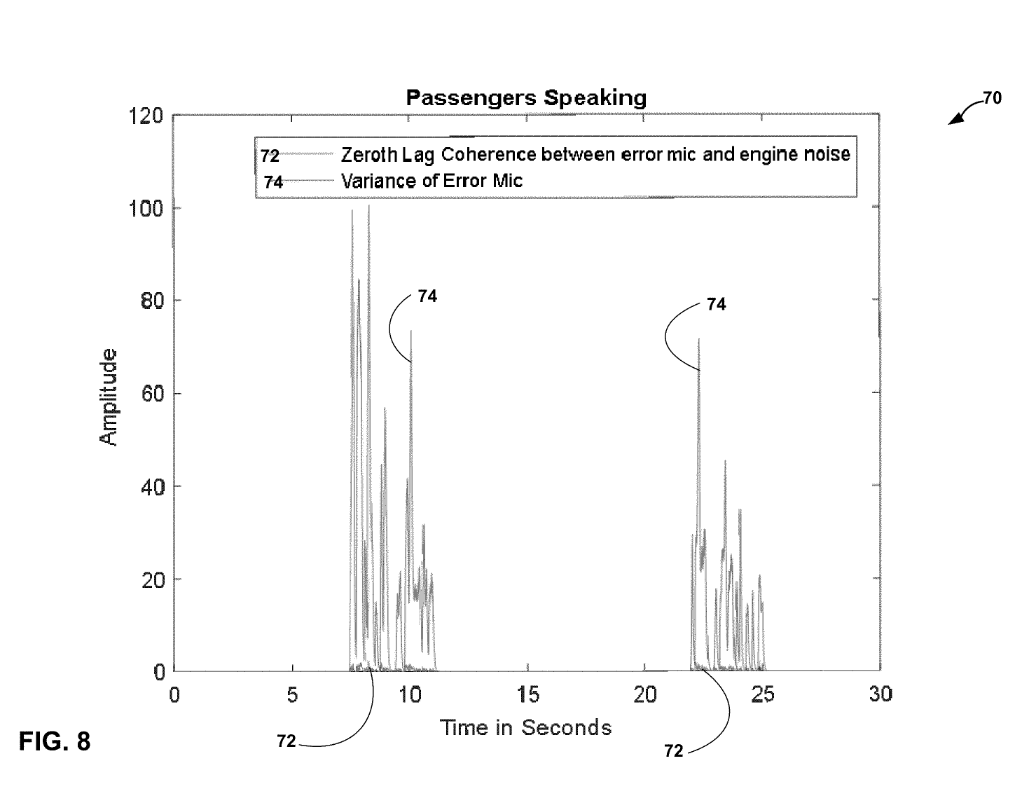

FIG. 8 is a graph 70 showing similarity measurement information between one particular type of engine-external noise (namely, the audio data of vehicle occupant(s) speaking), with the RPM measurements received from the PCM of the engine of the vehicle 60. Plot line 72 corresponds to a zeroth lag coherence between the data supplied by the error microphones 62 (e.g., an error signal e(n)), and the engine noise that the ANC apparatus A50 may determine using the RPM measurement(s) received from the PCM of the engine of the vehicle 60. Plot line 74 illustrates one or more energy parameters associated with the error signal e(n). As one non-limiting example, the plot line 74 may show the variance of the error signal e(n) with respect to the engine noise information based on the RPM measurements received from the PCM of the engine.

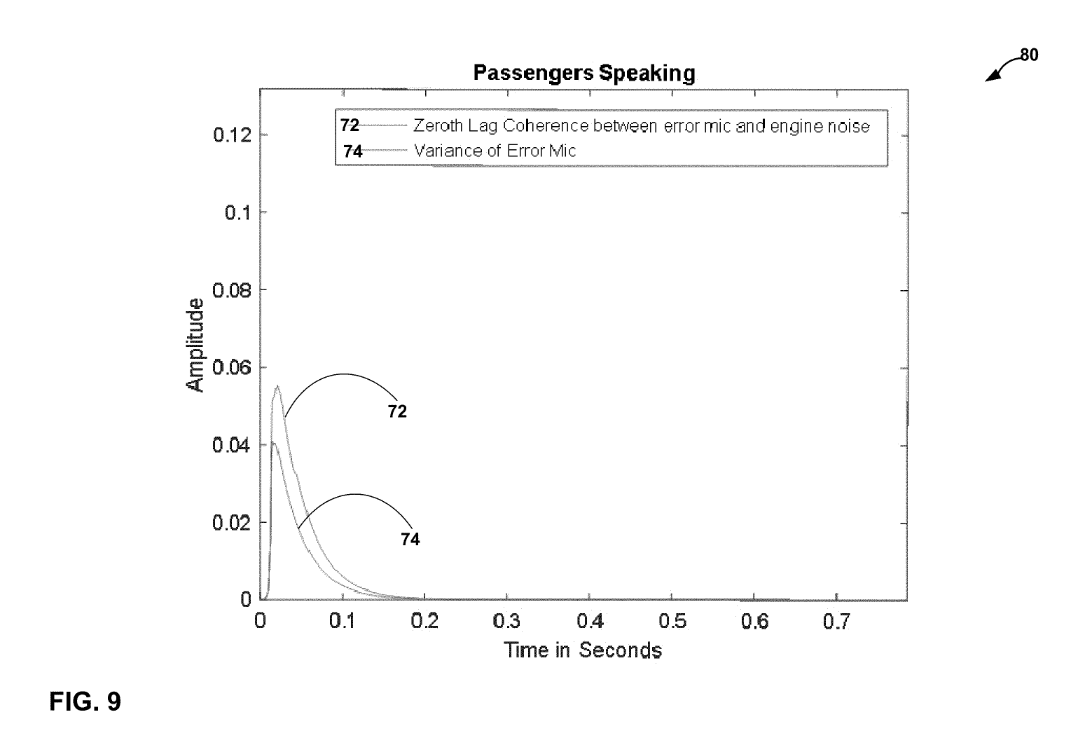

FIG. 9 is a graph 80 showing similarity measurement information between one particular type of engine-external noise (namely, the audio data of vehicle occupant(s) speaking), with the RPM measurements received from the PCM of the engine of the vehicle 60. Graph 80 shows a subsampling of data from the graph 70 of FIG. 8. Graph 80 illustrates initial convergence information that the ANC apparatus A50 may implement with respect to ANC filter convergence. The initial convergence shown in the graph 80 illustrates that, at the beginning, the error signal e(n) is not affected by unwanted disturbances, as the two plot lines do not diverge. Additionally, as shown by plot line 74 falling below plot line 72, the energy parameters (in this example, the expected variance) of the error signal e(n) provided by the error microphones 62 are smaller than the zeroth lag coherence between the error signal e(n) provided by error microphones 62 and the engine noise based on RPM measurements received from the PCM of the engine of the vehicle 60. In the use case scenario shown in FIG. 9, the ANC apparatus A50 may adapt the convergence using existing ANC techniques.

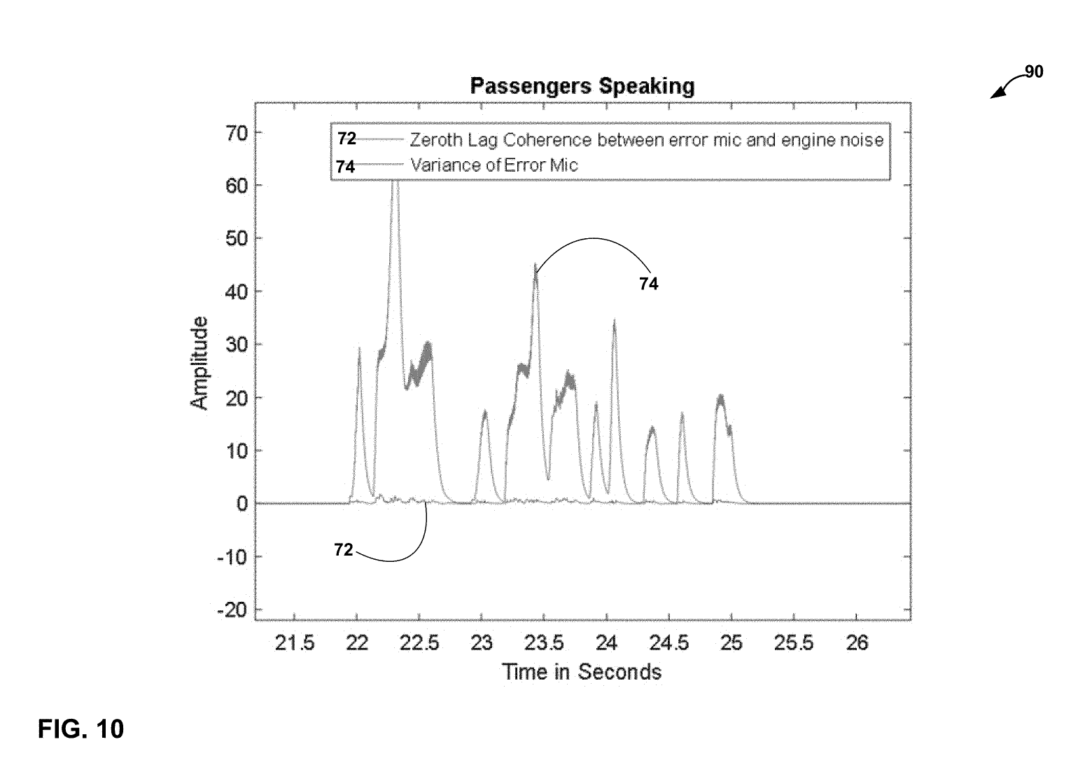

FIG. 10 is a graph 90 showing similarity measurement information between one particular type of engine-external noise (namely, the audio data of vehicle occupant(s) speaking), with the RPM measurements received from the PCM of the engine of the vehicle 60. Graph 90 shows a subsampling of data from the graph 70 of FIG. 8. The convergence subsampling shown in the graph 90 illustrates that, in the sampled portion, the energy parameters (in this example, the expected variance) of the error signal e(n) provided by the error microphones 62 are larger than the zeroth lag coherence between the error signal e(n) provided by error microphones 62 and the engine noise based on RPM measurements received from the PCM of the engine of the vehicle 60. In the use case scenario shown in FIG. 10, the ANC apparatus A50 may implement the techniques of this disclosure to slow the convergence of the ANC filters to cancel out ambient noise without diverging departing from the noise emanating from the engine of the vehicle 60.

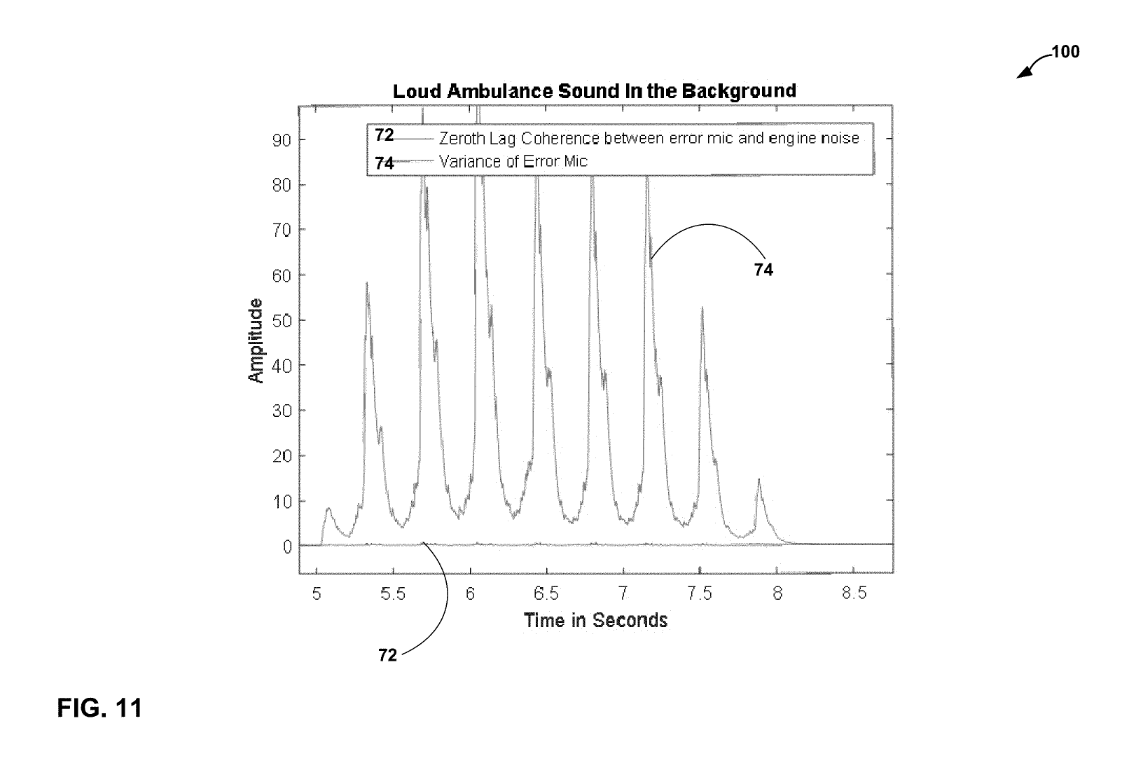

FIG. 11 is a graph 100 showing similarity measurement information between one particular type of engine-external noise (namely, the audio data of an ambulance, such as the siren of the ambulance), with the RPM measurements received from the PCM of the engine of the vehicle 60. The convergence information shown in the graph 100 illustrates that the energy parameters (in this example, the expected variance) of the error signal e(n) provided by the error microphones 62 are larger than the zeroth lag coherence between the error signal e(n) provided by error microphones 62 and the engine noise based on RPM measurements received from the PCM of the engine of the vehicle 60. In the use case scenario shown in FIG. 11, the ANC apparatus A50 may implement the techniques of this disclosure to slow the convergence of the ANC filters to cancel out ambient noise without diverging departing from the noise emanating from the engine of the vehicle 60.

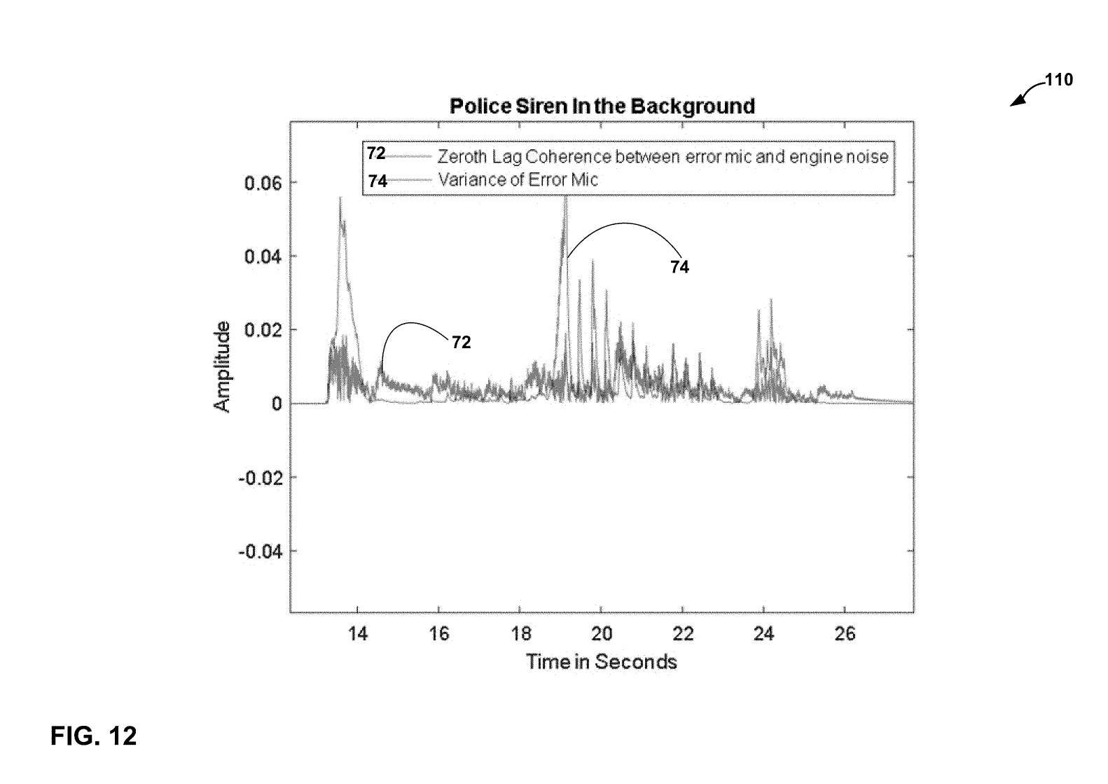

FIG. 12 is a graph 110 showing similarity measurement information between one particular type of engine-external noise (namely, the audio data of a siren of a police car), with the RPM measurements received from the PCM of the engine of the vehicle 60. The convergence information shown in the graph 110 illustrates that the energy parameters (in this example, the expected variance) of the error signal e(n) provided by the error microphones 62 are larger than the zeroth lag coherence between the error signal e(n) provided by error microphones 62 and the engine noise based on RPM measurements received from the PCM of the engine of the vehicle 60. In the use case scenario shown in FIG. 12, the ANC apparatus A50 may implement the techniques of this disclosure to slow the convergence of the ANC filters to cancel out ambient noise without diverging departing from the noise emanating from the engine noise.

According to various techniques of this disclosure, to effect any alteration in the step-size, the ANC apparatus A50 may change the magnitude of the step-size. That is, in these examples, the ANC apparatus A50 may not change how often or how frequently the ANC apparatus determines convergence parameters for the ANC filters, but rather, the magnitude of the change to the filter coefficients being converged, to form the altered-convergence ANC filtering coefficients.

The foregoing described techniques may also enable a non-transitory computer-readable storage medium having stored thereon instructions that, when executed, cause one or more processors to, when an estimated noise level increases, dynamically lower application of active noise cancellation to at least a portion of an audio signal to obtain at least a portion of an active noise cancelled version of the audio signal. The zeroth lag coherence between the error signal e(n) provided by microphones 62 and the delayed filtered RPM-based engine noise is denoted by the formula

$$= {( h - \hat{h} )}^{T} {R}_{x , x}$$

$${σ}_{e}^{2} = {( h - \hat{h} )}^{T} {R}_{x , x} ( h - \hat{h} ) + {σ}_{w}^{2} = {( h - \hat{h} )}^{T} {R}_{x , x}$$

where a is the variance of the error microphones 62 output in the vehicle 60 and a is the variance of unwanted noise other than the engine noise (e.g., unwanted engine-external noise captured by the error microphones 62).

The ANC apparatus A50 may determine that the error microphones 62 have captured unwanted engine-external noise in scenarios denoted by the following formula:

(h−ĥ)^{T}R_{X,X}(h−ĥ)+σ_{w}²>(h−ĥ)^{T}R_{X,X}

Which denotes a scenario in which

$$\begin{matrix}\text{?} \\ {σ}_{e}^{2} > ξ\end{matrix}$$

$$\text{?} \text{indicates text missing or illegible when filed}$$

shows the zeroth lag coherence between the error signal produced by the error microphones 62 and the delayed filtered RPM-based engine noise.

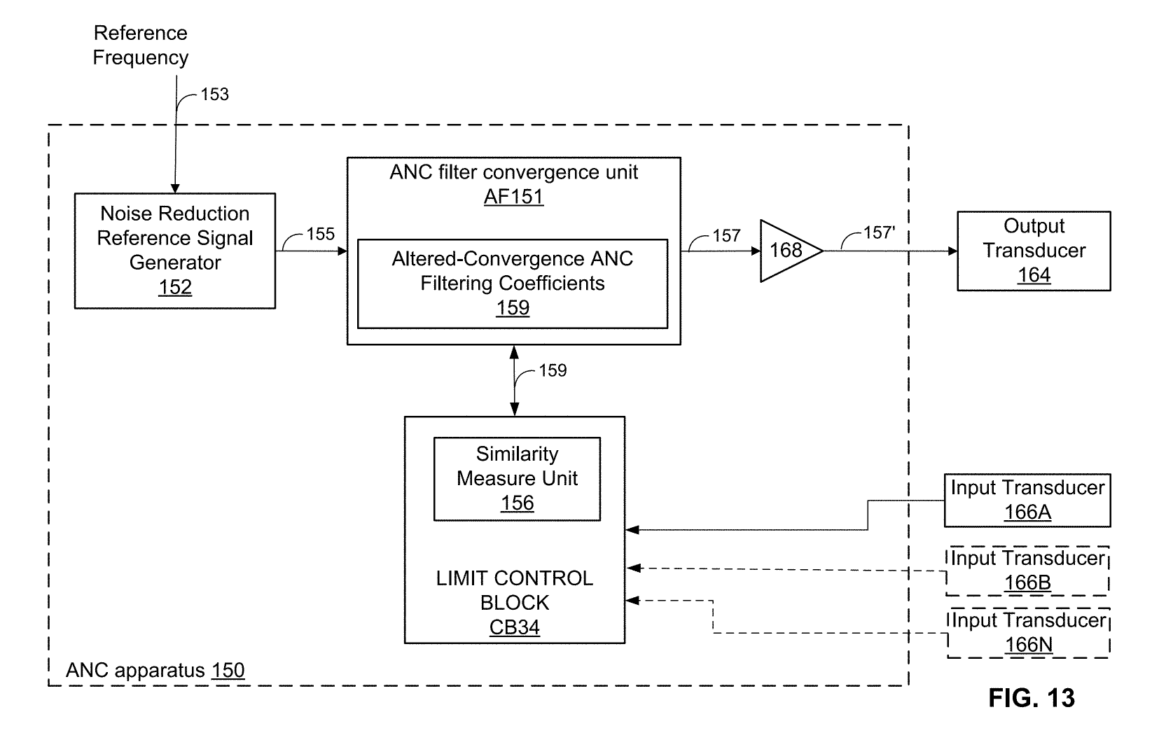

FIG. 13 is a block diagram illustrating an ANC apparatus 150 that may be configured to perform various aspects of the limited ANC output techniques described in this disclosure. ANC apparatus 150 may represent one example of above-described ANC apparatus A20 in that ANC apparatus 150 includes an ANC filter convergence unit AF151. Although not shown in the example of FIG. 13, ANC apparatus 150 may include or otherwise be coupled to a loudspeaker similar to loudspeaker LS10 shown in the example of FIG. 3, and a reference microphone similar to reference microphone MR 10 also shown in the example of FIG. 3.

According to various aspects of this disclosure, the ANC apparatus 150 (or components thereof, such as the limit control block CB34, the similarity measure unit 156, or ANC filter convergence unit AF151) illustrated in FIG. 13 may slow the convergence of ANC filter coefficients, based on a determination that the error signal received from input transducer(s) 166 shows a variance from the engine noise that is greater than a similarity measure between the engine noise and the error signal received from the input transducer(s) 166. For instance, if the similarity measure unit 156 determines that the energy parameters of the error signal received from the error signal received from the input transducer(s) 166 is greater than a predetermined similarity measure, then the limit control block CB34 may slow the convergence of filter coefficients associated with the ANC filter convergence unit AF151.

For instance, to slow the convergence of the filter coefficients, the limit control block CB34 may provide a set of altered-convergence ANC filtering coefficients 159 to the ANC filtering convergence unit AF151. As such, the altered-convergence ANC filtering coefficients 159 represent a result of the limit control block CB34 slowing the convergence (e.g., coefficient stabilization) between filtering coefficients that the ANC filtering convergence unit AF151 applies with the error signal received from the input transducer(s) 166. In this way, the limit control block CB34 may implement the techniques of this disclosure to delay the time taken to stabilize the filter coefficients associated with the error signal received from the input transducer(s) 166 to exclude relatively ephemeral engine-external noise from the generation of the noise cancellation signal 157. As such, the ANC apparatus 150 illustrated in FIG. 13 may implement the techniques of this disclosure to reduce or potentially eliminate the antinoise audio components of the noise cancellation signal 157 associated with engine-external noise received from the input transducer(s) 166.

As shown, the limit control block CB34 is coupled to the ANC filter convergence unit AF151 and the input transducer(s) 166 of the ANC apparatus 150. The ANC filter convergence unit AF151 is coupled to the output transducer 164 via a power amplifier 168. The optional nature of several of input transducers 166 is illustrated in FIG. 13 using dashed-line borders. In operation, a reference frequency, or information from which a reference frequency can be derived, is provided to the noise reduction reference signal generator 152. The noise reduction reference signal generator 152 may generate a noise reduction signal 155 (e.g., similar to noise-canceling signal SY10 illustrated in FIG. 3), which may be in the form of a periodic signal, such as a sinusoid having a frequency component related to the engine speed. The noise reduction reference signal generator 152 may provide the noise reduction signal 155 to the ANC filter convergence unit AF151.

The input transducer(s) 166 may detect periodic vibrational energy having a frequency component related to the reference frequency, and may transduce the vibrational energy to one or more noise signals, each noise signal corresponding to a particular one of the input transducer(s) 166. In turn, the input transducer(s) 166 may provide the noise signals to the limit control block CB34. The limit control block CB34 may determine, based on decision information determined from the similarity measure unit 156, ANC filter convergence information with respect to filter coefficients applied by the ANC filter convergence unit AF151. For instance, the limit control block CB34 may alter the convergence (e.g., by slowing down the stabilization) of the filter coefficients, to form the altered-convergence ANC filtering coefficients 159, and may provide the altered-convergence ANC filtering coefficients 159 to the ANC filtering convergence unit AF151.

As shown in FIG. 13, the ANC filter convergence unit AF151 may use the altered-convergence ANC filtering coefficients 159 received from the limit control block CB34 in filter convergence operations. For example, the ANC filter convergence unit AF151 may use the altered-convergence ANC filtering coefficients 159 to modify the amplitude and/or phase of the noise cancellation reference signal 155 received from the noise reduction reference signal generator 152, to form a modified noise cancellation signal 157.

The ANC filter convergence unit AF151 may provide the modified noise cancellation signal 157 to the power amplifier 168. In turn, the power amplifier 162 may amplify the modified noise reduction signal 157, and provide the amplified noise reduction signal 157′ to the output transducer 164. The output transducer 164 may transduce the amplified noise reduction signal 157′ into vibrational energy. Control block 162 controls the operation of the active noise reduction elements of the ANC apparatus 150, for example by activating or deactivating the active noise reduction system or by adjusting the amount of noise attenuation. The limit control block CB34 (with the similarity measure unit 156 included) and the ANC filter convergence unit AF151 operate repetitively and recursively to provide a stream of filter coefficients (e.g., the altered-convergence ANC filtering coefficients 159) that the ANC filter convergence unit AF151 may use to modify a signal that, when transduced to periodic vibrational energy, attenuates the vibrational energy detected by the input transducers 166.

The ANC filter convergence unit AF151 may apply multiple filters, each of which can be characterized by a respective transfer function H(s), to compensate for effects in the energy transduced by the input transducer(s) 166 of components of the active noise reduction system (including the power amplifier 168 and the output transducer 164) and of the environment in which the system operates. In accordance with the techniques of this disclosure, the ANC filter convergence unit AF151 may apply the altered-convergence ANC filtering coefficients 159 received from the limit control block CB34 to apply the multiple filters described above, in order to mitigate or potentially eliminate the effects of engine-external noise in generating the modified noise cancellation signal 157.

Input transducer(s) 166 may include, be, or be part of one of many types of devices that transduce vibrational energy to electrically or digitally encoded signals, such as an accelerometer, a microphone, a piezoelectric device, and others. In cases where there are multiple input transducers 166, the filtered inputs from the input transducers 166 may be combined in some manner, such as by averaging, or the input from one of the input transducers 166 may be weighted more heavily than the input from the others. The limit control block CB34, the similarity measure unit 156, and other components may be implemented as instructions executed by a microprocessor, such as a digital signal processing (DSP) device. The output transducer 164 can include, be, or be part of one of many electromechanical or electroacoustical devices that provide periodic vibrational energy, such as a motor or an acoustic driver.

According to various aspects of this disclosure, the ANC apparatus 150 (or components thereof, such as the limit control block CB34) may slow the convergence of the ANC filter coefficients to form altered-convergence ANC filtering coefficients 159, based on a determination by the similarity measure unit 156 that the error signal received from the input transducer(s) 166 shows a variance from the engine noise that is greater than a similarity measure between the engine noise and the error signal received from the input transducer(s) 166. For instance, the limit control block CB34 of the ANC apparatus 150 may slow the convergence of filter coefficients to form the altered-convergence ANC filtering coefficients 159. In turn, the ANC filtering convergence unit AF151 may apply the altered-convergence ANC filtering coefficients 159 to delay the stabilization of the filter coefficients, in order to reduce or potentially eliminate the antinoise audio components of the modified noise cancellation signal 157 associated with engine-external noise received from the input transducer(s) 166.

The altered-convergence ANC filtering coefficients 159, when applied by the ANC filter convergence unit AF151, represent an ANC filtering mechanism that the limit control block CB34 may provide to the ANC filter convergence unit AF151 to implement, in order to apply the slowed-convergence relationship between the filters coefficients applied to the error signal received from the input transducer(s) 166. That is, the ANC filter convergence unit AF151 may reduce the speed of the stabilization of multiple filters coefficients (e.g., by reducing the step-size of a learning algorithm associated therewith) by applying the altered-convergence ANC filtering coefficients 159. That is, the altered-convergence filtering coefficients 159, when applied by the ANC filter convergence unit AF151, represent a result of the limit control block CB34 and the ANC filter convergence unit AF151 implementing one or more techniques of this disclosure to alter (e.g., slow) the convergence of the filters coefficients being applied to the error signal received from the input transducer(s) 166. For instance, the altered-convergence filtering coefficients 159, when applied, enable the ANC apparatus 150 to reduce or potentially eliminate the generation of antinoise audio data in the modified noise cancellation signal 157 that would otherwise target engine-external (and therefore, largely ephemeral) noise. That is, the altered-convergence filtering coefficients 159, when applied by the ANC filter convergence unit AF151, enables the ANC filter convergence unit AF151 to avoid generating the modified noise cancellation signal 157 in such a way as to include antinoise audio that targets noise (e.g., engine-external noise) that is likely to have ceased prior to the any updating of the antinoise data under existing ANC technology.

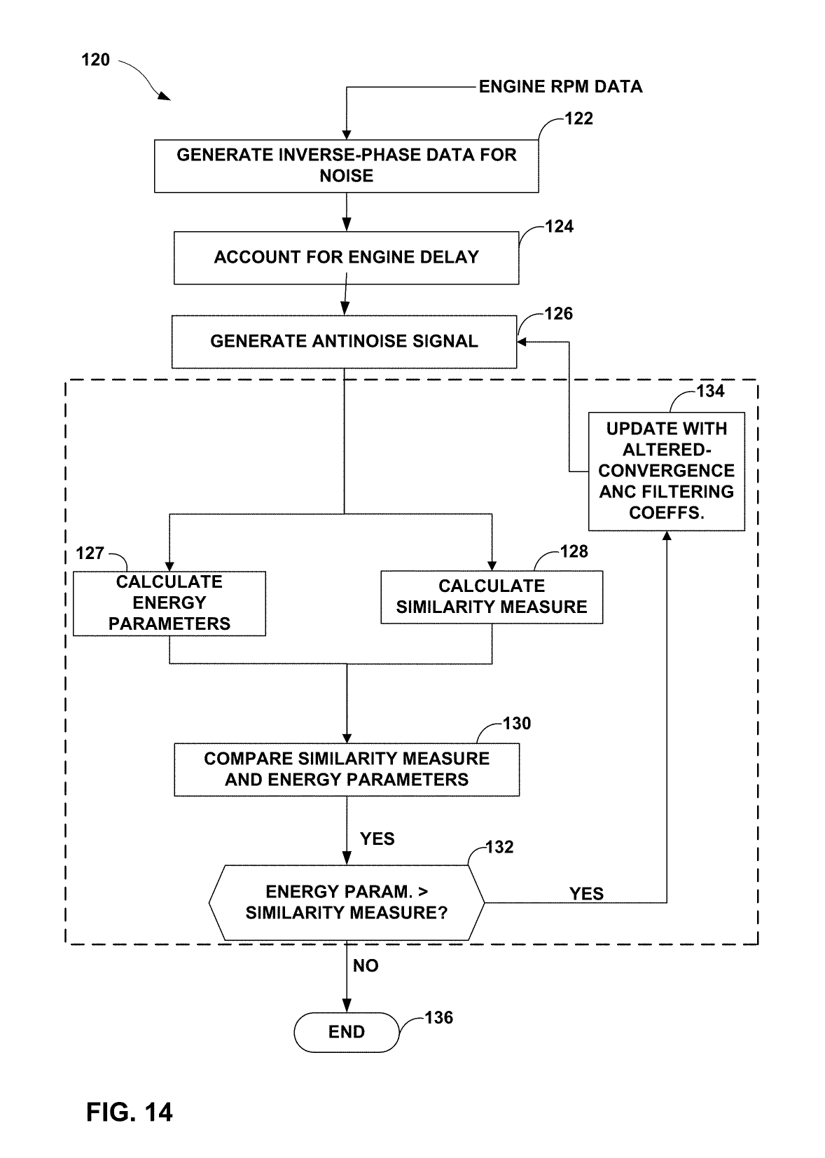

FIG. 14 is a flowchart illustrating an example process 120, by which the ANC apparatus A50 may implement one or more of the enhanced ANC technologies of this disclosure. Process 120 may begin when the ANC apparatus A50 receives engine RPM data from the PCM of the vehicle 60. Based on noise data associated with the current RPM data received from the PCM of the engine, the ANC apparatus A50 may generate phase-inverted versions of the projected engine noise (122). As discussed above, the phase-inverted version of the projected engine noise may form a noise-canceling component of an audio feed that is played back via the loudspeakers of the cabin of the vehicle 60. In turn, the ANC apparatus A50 may account for engine delay (124). Using the phase-inverted audio data and the engine delay timing information, the ANC apparatus may generate an antinoise signal (126).

In turn, the ANC apparatus A50 may perform two calculations. More specifically, the ANC apparatus A50 may calculate energy parameters associated with the error signal e(n) received from the error microphones 62 (127) and a similarity measure between the error signal e(n) and the engine noise (128). An example of the energy parameters that the ANC apparatus A50 may calculate with respect to the error signal e(n) is a variance of the error signal e(n) with respect to the engine noise calculation based on the RPM data received from the PCM of the engine. In turn, the ANC apparatus A50 may compare the similarity score to the energy parameters (130). Based on whether or not the energy parameters (as one non-limiting example, the variance) is greater than the similarity score (decision block 132), the ANC apparatus may perform different operations. If the energy parameters are not greater than (e.g., by being less than or equal to) the similarity measure, then the ANC apparatus A50 may end (136) process 120. For instance, the ANC apparatus A50 may continue with ANC implementation without altering the convergence of the ANC filter coefficients.

However, if the ANC apparatus A50 determines that the energy parameters (as one non-limiting example, the variance) are greater than the similarity measure, then the ANC apparatus A50 may update the ANC filter convergence using the altered-convergence ANC filtering coefficients 159 (134). For instance, the ANC apparatus A50 may slow the convergence of filter coefficients for two or more ANC filters associated with various components of the error signal e(n) received from the error microphones 62, to form the altered-convergence ANC filtering coefficients 159. By slowing the convergence of the ANC filter coefficients to form the altered-convergence ANC filtering coefficients 159, the ANC apparatus A50 may implement the techniques of this disclosure to reduce or potentially eliminate unwanted noise-canceling sounds (e.g., which may address now-obsolete engine-external noise) in the antinoise signal generated at step 126. In this way, the process 120 of FIG. 14 illustrates an example in which the ANC apparatus A50 may perform ANC convergence alterations in response to specific determination that the energy parameters of the error signal e(n) are greater than the similarity measure between the error signal e(n) and the projected engine noise.

In this way, FIG. 14 illustrates that, according to aspects of this disclosure, an in-vehicle audio system may configured to perform a method that includes receiving, by adaptive noise-canceling (ANC) circuitry (e.g., the ANC circuitry 14) of the in-vehicle audio system, one or more revolutions per minute (RPM) measurements associated with a vehicle engine from a powertrain control module (PCM) coupled to the vehicle engine, generating, by the ANC circuitry 14 of the in-vehicle audio system, a phase-inverted version of projected engine noise data based on the received RPM measurements, and generating, by the ANC circuitry 14 of the in-vehicle audio system, an antinoise signal based on the phase-inverted version of the projected engine noise and engine delay information. The method further includes calculating, by the ANC circuitry 14 of the in-vehicle audio system, energy parameter data associated with an error signal received from one or more error microphones positioned in the vehicle, and calculating, by the ANC circuitry 14 of the in-vehicle audio system, a similarity measure between the error signal and the projected engine noise. The method may include performing, by the ANC circuitry 14 of the in-vehicle audio system, responsive to determining that the energy parameter data does not exceed the similarity measure, ANC using the generated antinoise signal. The method may include updating, by the ANC circuitry 14 of the in-vehicle audio system, responsive to determining that the energy parameter data exceeds the similarity measure, an ANC filter convergence associated with the antinoise signal to form an updated antinoise signal, and performing ANC using the updated antinoise signal. The dashed-line box in FIG. 14 indicates a set of steps that the limit control block CB34 may perform, in examples where the ANC apparatus 150 of FIG. 13 is configured to perform the process 120 of FIG. 14.

In this way, FIG. 14 illustrates that, according to aspects of this disclosure, an in-vehicle audio system may include means for obtaining one or more revolutions per minute (RPM) measurements associated with a vehicle engine from a powertrain control module (PCM) coupled to the vehicle engine, means for generating, by the ANC circuitry of the in-vehicle audio system, a phase-inverted version of projected engine noise data based on the obtained RPM measurements, means for generating an antinoise signal based on the phase-inverted version of the projected engine noise and engine delay information, and means for calculating energy parameter data associated with an error signal received from one or more error microphones positioned in the vehicle. The in-vehicle audio system may further include means for calculating a similarity measure between the error signal and the projected engine noise, means for performing, responsive to determining that the energy parameter data does not exceed the similarity measure ANC using the generated antinoise signal, means for updating, responsive to determining that the energy parameter data exceeds the similarity measure, an ANC filter convergence associated with the antinoise signal to form an updated antinoise signal, and means for performing, responsive to determining that the energy parameter data exceeds the similarity measure, ANC using the updated antinoise signal.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention have been described. These and other embodiments are within the scope of the following claims.

What is claimed is:

1. An in-vehicle audio system comprising:
one or more error microphones configured to capture:
engine noise associated with a vehicle engine, and
engine-external noise associated with one or more sources different from the vehicle engine;
adaptive noise-canceling (ANC) circuitry coupled to the one or more error microphones, the ANC circuitry being configured to:
process audio data received from the one or more error microphones to determine a distinction between the engine-external noise and the engine noise; and
based on the distinction determined between the engine-external noise and the engine noise, alter a convergence between two or more ANC filters to form altered-convergence ANC filtering coefficients; and
one or more speakers coupled to the ANC circuitry, configured to apply the altered-convergence ANC filtering coefficients to the processed audio data to add a noise-canceling component to the processed audio data to form noise-canceled audio data.

2. The in-vehicle audio system of claim 1, the ANC circuitry being further configured to slow the convergence between the two or more ANC filters to form the altered-convergence ANC filtering coefficients.

3. The in-vehicle audio system of claim 1, the ANC circuitry being further configured to:
obtain, from a powertrain control module (PCM) coupled to the vehicle engine, one or more revolutions per minute (RPM) measurements associated with the vehicle engine;
generate a plurality of signals based on a sine wave frequency associated with a current RPM measurement of the one or more RPM measurements obtained from the PCM;
determine a similarity measure between the generated plurality of signals and the processed audio data received from the one or more error microphones; and
use the determined similarity measure to generate the altered-convergence ANC filtering coefficients.

4. The in-vehicle audio system of claim 3,
wherein the plurality of generated signals comprises two time-domain signals, and
wherein the similarity measure comprises one or more of a spectral coherence, a time correlation, or a magnitude-squared coherence between the two time-domain signals.

5. The in-vehicle audio system of claim 3, the ANC circuitry being further configured to:
based on the determined coherence, alter a step-size of a learning algorithm associated with the RPM measurements obtained from the PCM.

6. The in-vehicle audio system of claim 1, the ANC circuitry being further configured to:
slow a convergence of respective coefficients of the two or more ANC filters to alter the convergence of the two or more ANC filters.

7. The in-vehicle audio system of claim 1, the in-vehicle audio system further comprising:
one or more system-control microphones configured to capture voice commands.

8. The in-vehicle audio system of claim 1, the ANC circuitry being configured to: suppress the noise-canceled audio data at the one or more system-control microphones.

9. An in-vehicle audio system comprising:
one or more error microphones configured to capture:
engine noise associated with a vehicle engine, and
engine-external noise associated with one or more sources different from the vehicle engine; and
adaptive noise-canceling (ANC) circuitry coupled to the one or more error microphones, the ANC circuitry being configured to:
process audio data received from the one or more error microphones to determine a distinction between the engine-external noise and the engine noise; and
based on the distinction determined between the engine-external noise and the engine noise, alter a convergence between two or more ANC filters to form altered-convergence ANC filtering coefficients.

10. The in-vehicle audio system of claim 9, wherein the ANC circuitry is further configured to output the processed audio data, the in-vehicle audio system further comprising:
one or more speakers coupled to the ANC circuitry, configured to:
receive the processed audio data output by the ANC circuitry; and
apply the altered-convergence ANC filtering coefficients to the processed audio data to add a noise-canceling component to the processed audio data to form noise-canceled audio data.

11. A method comprising:
capturing, by one or more error microphones of an in-vehicle audio system, engine noise associated with a vehicle engine; and
capturing, by the one or more error microphones of the in-vehicle audio system, engine-external noise associated with one or more sources different from the vehicle engine;
processing, by adaptive noise-canceling (ANC) circuitry of the in-vehicle audio system, audio data received from the one or more error microphones to determine a distinction between the engine-external noise and the engine noise; and
altering, by the ANC circuitry of the in-vehicle audio system, a convergence between two or more ANC filters to form altered-convergence ANC filtering coefficients, based on the distinction determined between the engine-external noise and the engine noise.

12. The method of claim 11, further comprising outputting, by the ANC circuitry of the in-vehicle audio system, the processed audio to one or more speakers of the in-vehicle audio system

13. The method of claim 12, further comprising applying, by the one or more speakers of the in-vehicle audio system, the altered-convergence ANC filtering coefficients to the processed audio data to add a noise-canceling component to the processed audio data to form noise-canceled audio data.

14. A method comprising:
receiving, by adaptive noise-canceling (ANC) circuitry of an in-vehicle audio system, one or more revolutions per minute (RPM) measurements associated with a vehicle engine from a powertrain control module (PCM) coupled to the vehicle engine;
generating, by the ANC circuitry of the in-vehicle audio system, a phase-inverted version of projected engine noise data based on the received RPM measurements;
generating, by the ANC circuitry of the in-vehicle audio system, an antinoise signal based on the phase-inverted version of the projected engine noise and engine delay information;
calculating, by the ANC circuitry of the in-vehicle audio system, energy parameter data associated with an error signal received from one or more error microphones positioned in the vehicle;
calculating, by the ANC circuitry of the in-vehicle audio system, a similarity measure between the error signal and the projected engine noise; and
performing one of:
responsive to determining that the energy parameter data does not exceed the similarity measure, performing, by the ANC circuitry of the in-vehicle audio system, ANC using the generated antinoise signal; or
responsive to determining that the energy parameter data exceeds the similarity measure:
updating, by the ANC circuitry of the in-vehicle audio system, an ANC filter convergence associated with the antinoise signal to form an updated antinoise signal; and
performing ANC using the updated antinoise signal.

15. The method of claim 14, further comprising slowing, by the ANC circuitry of the in-vehicle audio system, the ANC filter convergence to alter the ANC filter convergence.

16. The method of claim 14, wherein the energy parameter data comprises a variance of the error signal with respect to the projected engine noise.
